(19) United States
(12) Patent Application Publication
(10) Pub. No.: US 2026/0138827 A1
(43) Pub. Date: May 21, 2026

(54) SYSTEM AND METHOD FOR AUTONOMOUS ORDER FULFILLMENT

(71) Applicant: Fulfil Solutions, Inc., Mountain View, CA (US)

(72) Inventors: Eric Yehl, San Francisco, CA (US); Arni Lehto, Pittsburgh, PA (US); Houshine Sabbaghzadeh, San Francisco, CA (US); Michael Connerton, Santa Clara, CA (US); Arthur Cheung, San Francisco, CA (US); Nigel Bess, Berkeley, CA (US)

(21) Appl. No.: 19/391,536

(22) Filed: Nov. 17, 2025

Related U.S. Application Data
(60) Provisional application No. 63/721,355, filed on Nov. 15, 2024.
(60) Provisional application No. 63/748,299, filed on Jan. 22, 2025.

(51) Int. Cl. B65G 1/137

(52) U.S. Cl. CPC B65G 1/1375; B65G 1/065; B65G 3/04; B65G 47/34; G07F 11/1653; G07F 11/58

(57) ABSTRACT

One variation of a system includes: a population of trays storing product units; a dispensing unit configured to dispense product units from the population of trays; a mobile robotic system; and a controller. The mobile robotic system includes: a receptacle configured to support a base and a first sidewall of a semi-rigid container transiently loaded in the receptacle at an angle; and a sidewall retainer configured to retain a second sidewall of the semi-rigid container. The controller is configured to: trigger the mobile robotic system to navigate to a dispensing unit loaded with a tray transiently storing product units of a product type specified in an order; trigger the mobile robotic system to maneuver the receptacle to locate the semi-rigid container to receive the product unit at a target position; and trigger the dispensing unit to dispense the product unit into the semi-rigid container.

### CROSS-REFERENCE TO RELATED APPLICATIONS

This Application claims the benefit of U.S. Provisional Application No. 63/748,299, filed on 22 Jan. 2025, and U.S. Provisional Application No. 63/721,355, filed on 15 Nov. 2024, each of which is incorporated in its entirety by this reference.

### TECHNICAL FIELD

This invention relates generally to the field of online order fulfillment operations and, more specifically, to a new and useful system for autonomous order fulfillment in the field of online order fulfillment operations.

### BRIEF DESCRIPTION OF THE FIGURES

FIGS. 1A and 1B are schematic representations of a system;

FIGS. 2A and 2B are schematic representations of one variation of the system;

FIG. 3 is a schematic representation of one variation of the system;

FIG. 4 is a schematic representation of one variation of the system;

FIG. 5 is a schematic representation of one variation of the system;

FIG. 6 is a flowchart representation of a method;

FIG. 7 is a flowchart representation of one variation of the method; and

FIG. 8 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

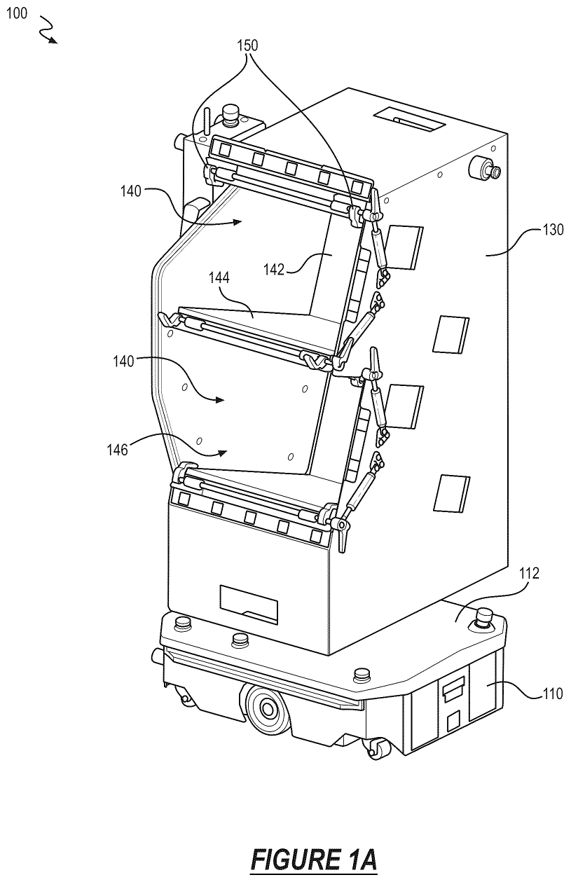

As shown in FIGS. 1A-5, an order fulfillment system 100 includes: a population of trays 102 configured to transiently store product units; a set of storage racks configured to transiently store the population of trays 102; a set of dispensing units 104 configured to transiently receive the population of trays 102 and dispense product units transiently stored within the population of trays 102; a tray-routing system (e.g., a conveyor, a miniload gantry crane) configured to transfer the population of trays 102 between the set of storage racks and the set of dispensing units 104; a set of totes 130, each tote 130 in the set of totes 130 configured to transiently receive a rigid or semi-rigid container (e.g., a bag, a box, a bin) to receive products dispensed by the set of dispensing units 104; a bag loader 170 configured to load bags into the set of totes 130; a mobile robotic system 110 defining a tote seat 116 configured to transiently receive a tote 130 in the set of totes 130; and a central controller configured to trigger actions by the set of dispensing units 104, tray-routing system, the bag loader 170, and the mobile robotic system 110.

### 1.1 Storage Racks and Trays

The set of storage racks are arranged in an order fulfillment facility and define a corpus of slots, each slot in the corpus of slots configured to store an individual tray 102 in the population of trays 102. Each tray 102 in the population of trays 102 is loaded with product units of multiple product types and configured to transiently store within a slot in the corpus of slots of the set of storage racks. Each tray 102 in the population of trays 102 includes an opening and a set of supports, the set of supports: defining a set of lanes within the tray 102; and configured to support product units within the set of lanes.

### 1.2 Dispensing Units

Each dispensing unit 104 in the set of dispensing units 104 faces a loading zone and is configured to: receive a tray 102 in the population of trays 102; and selectively dispense individual product units from the tray 102 toward the loading zone. Each dispensing unit 104 includes a set of dispensing arms 106 configured to: pass through an opening of the tray 102 toward the set of supports; elevate through a lane defined between a pair of supports in the set of supports to lift a row of product units, stored in the lane between the pair of supports, above the lane; and drive the row of product units forward toward the loading zone. Each dispensing unit 104 further includes an optical sensor 160 facing the loading zone.

### 1.3 Tray-Routing System

The tray-routing system is configured to: retrieve a tray 102 from a slot in the corpus of slots of the storage rack; and maneuver the tray 102 through a tray-routing network to locate the tray 102 within a dispensing unit 104, in the set of dispensing units 104, assigned to the tray 102 for dispensation of product units transiently stored in the tray 102.

The tray-routing system is further configured to: retrieve the tray 102 from the dispensing unit 104; and maneuver the tray 102 through the tray-routing network to locate the tray 102 within the slot for temporary storage of the tray 102.

### 1.4 Tote

Each tote 130 in the set of totes 130 includes a rigid housing and is configured to transiently receive and support a rigid or semi-rigid container. Each tote 130 in the set of totes 130 includes an upward-facing aperture 146 configured to receive and release the semi-rigid container. In one variation, the tote 130 includes: a side-facing aperture; and an upward-facing aperture 146 that cooperates with the side-facing aperture to receive and release the semi-rigid container. Each tote 130 in the set of totes 130 is configured to transiently locate in a semi-rigid container at a pitch angle between 10 degrees and 45 degrees.

In one implementation, the tote 130 includes a sidewall retainer 150 configured to retain a sidewall of the semi-rigid container occupying a receptacle 140 of the tote 130. In one example, the tote 130 includes a set of clips: arranged proximal the upward-facing aperture 146; and configured to retain a first edge of the semi-rigid container, the first edge of the semi-rigid container vertically offset above a second opposing edge of the semi-rigid container when the semi-rigid container occupies a receptacle 140 of the tote 130.

### 1.5 Bag Loader

The bag loader 170 is configured to: receive a tote 130 devoid of a semi-rigid container; receive the semi-rigid container in a collapsed (i.e., closed or flattened) position; transition the semi-rigid container from the collapsed position to the expanded position; load the semi-rigid container into the tote 130 in the expanded position; and load the tote 130 on the tote seat 116 of the mobile robotic system 110.

### 1.6 Mobile Robotic System

The mobile robotic system 110 includes: a mobile platform 112; and a local controller. The mobile platform 112 defines the tote seat 116: supported on and arranged over the mobile platform 112; and configured to transiently receive a tote 130 in the set of totes 130.

The local controller is configured to receive a fulfillment command, associated with a fulfillment order, from the central controller. The local controller is further configured to, based on the fulfillment command: trigger the mobile platform 112 to autonomously navigate to the bag loader 170 to receive the tote 130 at the tote seat 116; trigger the mobile platform 112 to autonomously navigate to a loading zone adjacent a dispensing unit 104 loaded with a tray 102 containing product units of a product type specified in the fulfillment order; trigger the mobile platform 112 to autonomously align the receptacle 140 to the dispensing unit 104 to receive a product unit of the product type; and trigger the mobile platform 112 to autonomously navigate to an unloading zone within the order fulfillment facility for removal of the semi-rigid container from the receptacle 140.

### 1.7 Central Controller

The central controller is configured to: receive a fulfillment order specifying a quantity of product units of a product type; and identify the tray 102, in the population of trays 102, transiently storing product units of the product type.

The central controller is further configured to generate the fulfillment command associated with the fulfillment order and specifying: the mobile robotic system 110; the tray 102; the dispensing unit 104; and dispensation of the quantity of product units of the product type from the tray 102 into the mobile robotic system 110 occupying the loading zone proximal the dispensing unit 104.

The central controller is further configured to disseminate the fulfillment command to the mobile robotic system 110.

### 1.8 Variation: Mobile Robotic System With Integrated Receptacle

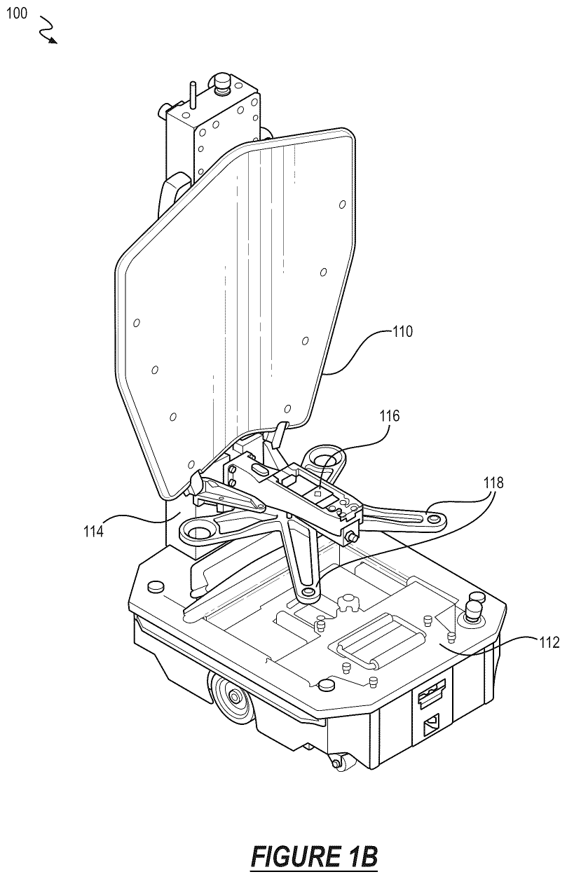

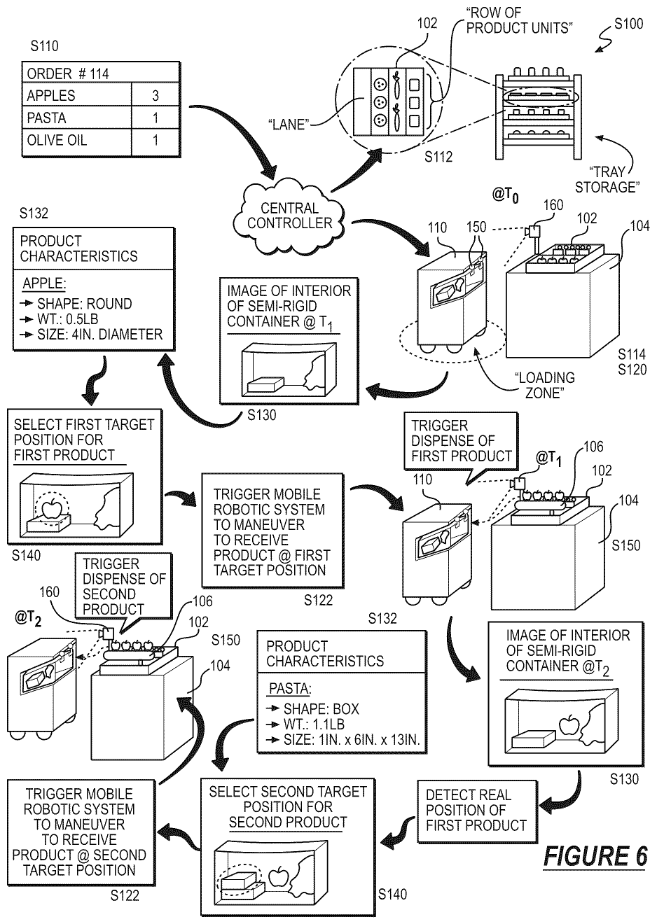

As shown in FIGS. 2A, 2B, and 6, one variation of the order fulfillment system 100 includes: a population of trays 102 configured to transiently store product units; a dispensing unit 104, in a set of dispensing units 104, configured to dispense product units stored in the population of trays 102; a mobile robotic system 110; and a controller.

The mobile robotic system 110 includes: a mobile platform 112; a receptacle 140 arranged over the mobile platform 112; and a sidewall retainer 150. The receptacle 140 is configured to: transiently house a semi-rigid container; support a first sidewall of the semi-rigid container at an angle, angularly offset from a horizontal plane by a pitch offset; and support a base of the semi-rigid container. The sidewall retainer 150 is configured to retain a second sidewall, opposite the first sidewall, of the semi-rigid container to maintain access to an interior volume of the semi-rigid container.

The mobile robotic system 110 is configured to: navigate to a loading zone proximal the dispensing unit 104, the dispensing unit 104 loaded with a tray 102, in the population of trays 102, storing product units; and maneuver within the loading zone to align the semi-rigid container to the dispensing unit 104 to receive a product unit within the semi-rigid container.

The controller is configured to: receive an order specifying product types of product units; identify the tray 102, in the population of trays 102, transiently storing product units of a product type specified in the order; assign the dispensing unit 104 for dispensation of the product unit transiently stored in the tray 102; trigger the mobile robotic system 110 to navigate to the loading zone proximal the dispensing unit 104; trigger the mobile robotic system 110 to maneuver within the loading zone to locate the semi-rigid container to receive the product unit within the semi-rigid container; and trigger the dispensing unit 104 to dispense the product unit into the semi-rigid container.

### 1.9 Variation: Mobile Robotic System+Tote

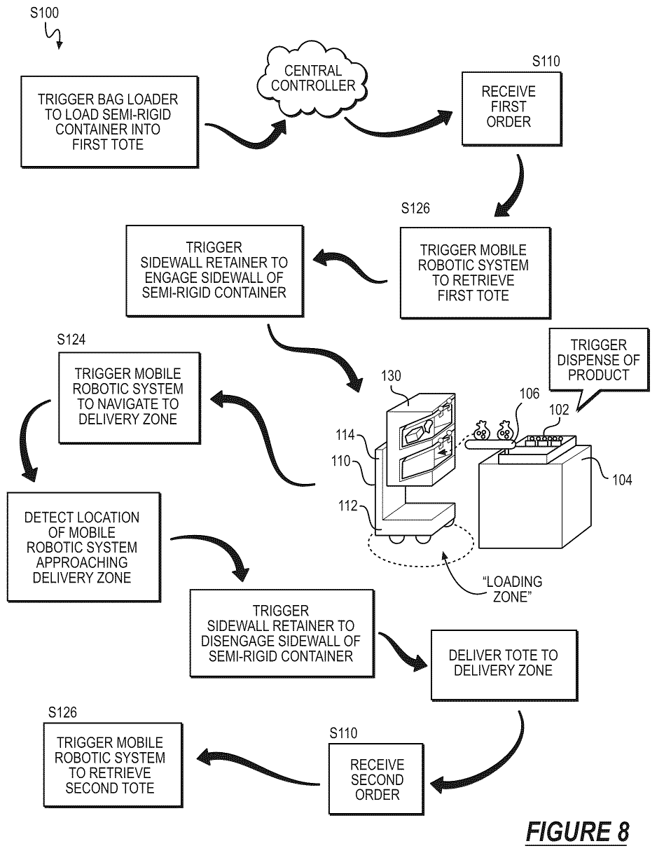

As shown in FIGS. 1A, 1B, 3, 7, and 8, one variation of the order fulfillment system 100 includes: a tote 130, in a set of totes 130, including a receptacle 140 configured to transiently house a semi-rigid container and a sidewall retainer 150 configured to maintain access to an interior volume of the semi-rigid container; a mobile robotic system 110 defining a tote seat 116 configured to transiently house a tote 130 in the set of totes 130; and a controller.

The receptacle 140 is configured to: support a sidewall of the semi-rigid container at an angle, angularly offset from a horizontal plane by a pitch offset; and support a base of the semi-rigid container.

The mobile robotic system 110 is configured to: receive the tote 130 at the tote seat 116; navigate to a loading zone proximal a dispensing unit 104, the dispensing unit 104 configured to dispense product units from a tray 102, loaded in the dispensing unit 104, toward the loading zone; and maneuver the tote 130 to align the semi-rigid container to the dispensing unit 104 to receive product units within the semi-rigid container.

The controller is configured to: receive an order specifying product types of product units; trigger the mobile robotic system 110 to navigate to the loading zone proximal the dispensing unit 104; trigger the mobile robotic system 110 to maneuver within the loading zone to locate the semi-rigid container to receive the product unit within the semi-rigid container; and trigger the dispensing unit 104 to dispense the product unit into the semi-rigid container.

### 1.10 Variation: Mobile Robotic System With Elevator

As shown in FIGS. 1A-1B, 2A-2B, 3, and 6-8, one variation of the order fulfillment system 100 includes a mobile robotic system 110 including: a mobile platform 112; a receptacle 140 arranged over the mobile platform 112 and configured to transiently house a semi-rigid container; a sidewall retainer 150; and an elevator 114.

The receptacle 140 includes: a receptacle base 142 configured to support a base of the semi-rigid container; and a receptacle wall 144 extending from the receptacle base 142 and configured to support a first sidewall of the semi-rigid container at an angle angularly offset from a horizontal plane by a pitch offset. The sidewall retainer 150 is configured to retain a second sidewall, opposite the first sidewall, of the semi-rigid container to maintain access to an interior volume of the semi-rigid container. The elevator 114 is configured to locate the receptacle 140 over a range of vertical positions.

The mobile robotic system 110 is configured to: navigate to a loading zone proximal a dispensing unit 104, in a set of dispensing units 104, the dispensing unit 104 loaded with a tray 102, in a population of trays 102, storing product units; laterally maneuver within the loading zone to align the semi-rigid container to the dispensing unit 104 to receive a product unit, dispensed by the dispensing unit 104, at a target lateral position within the semi-rigid container; vertically maneuver the receptacle 140 to locate the semi-rigid container to receive the product unit at a target vertical position within the semi-rigid container; and receive the product unit, dispensed by the dispensing unit 104, within the semi-rigid container.

### 2. Method

As shown in FIGS. 6-8, a method S100 for automating order fulfillment within an order fulfillment facility includes: receiving a fulfillment order specifying a quantity of product units of a product type in Block S110; identifying a tray 102, in a population of trays 102, transiently storing product units of the product type in Block S112; and assigning a dispensing unit 104, in a set of dispensing units 104, for dispensation of product units transiently stored in the tray 102 in Block S114.

The method S100 further includes generating a fulfillment command associated with the fulfillment order and specifying: a mobile robotic system 110; the tray 102; the dispensing unit 104; and dispensation of the quantity of product units of the product type from the tray 102 into the mobile robotic system 110. The method further includes transmitting the fulfillment command to the mobile robotic system 110.

The method S100 further includes triggering the mobile robotic system 110 to: retrieve a tote 130 loaded with a semi-rigid container configured to receive products; and maneuver the tote 130 to a loading zone proximal the dispensing unit 104 in Block S120.

The method S100 further includes: accessing an image, depicting an interior volume of the semi-rigid container, captured by an optical sensor 160 arranged within the dispensing unit 104 and facing the loading zone in Block S130; accessing a set of characteristics (e.g., size, shape, mass, fragility score) of the product type in Block S132; deriving a target position (e.g., a target unoccupied subvolume) for receiving the product unit within the semi-rigid container based on the image and the set of characteristics of the product type in Block S140; and triggering the mobile platform 112 to align the tote 130 to the dispensing unit 104 to receive a product unit of the product type in the target unoccupied subvolume within the semi-rigid container in Block S122.

The method S100 further includes triggering the dispensing unit 104 to dispense the quantity of product units of the product type into the semi-rigid container loaded into the mobile robotic system 110 occupying the loading zone in Block S150.

The method S100 further includes, in response to detecting presence of the quantity of product units within the semi-rigid container (e.g., via a weight sensor arranged on the mobile robotic system 110), triggering the mobile robotic system 110 to maneuver the tote 130 to an unloading zone within the order fulfillment facility for removal of the semi-rigid container from the tote 130.

### 3. Applications

Generally, a mobile robotic system 110 is deployed in an order fulfillment facility (e.g., a grocery store stockroom) and is configured: to receive a fulfillment command associated with a fulfillment order; to retrieve a tote 130 configured to receive products within a rigid or semi-rigid container (e.g., a paper bag, a reusable tote bag, a cardboard box, a plastic bin) transiently loaded within the tote 130; to autonomously navigate to a loading zone adjacent a dispensing unit 104 loaded with a tray 102 containing product units of a product type specified in the fulfillment order; to autonomously align the tote 130 to the dispensing unit 104 to receive a product unit of the product type within the semi-rigid container; and to deliver the tote 130 to an unloading zone (e.g., a storefront, or a self-service pickup locker system) for retrieval of the semi-rigid container by a customer or a delivery worker.

In particular, at the order fulfillment facility, products (e.g., incoming products from a supplier) may be loaded into a population of trays 102 (i.e., configured to transiently store products) proximal a tray 102 loading zone arranged upstream of a set of dispensing units 104. Then, each tray 102 in the population of trays 102 may maneuver through a tray-routing network prior to arriving at a dispensing unit 104, in the population of dispensing units 104. More specifically, the order fulfillment facility may include a set of dispensing units 104 configured to: transiently store a population of products (e.g., grocery items, apparel items, or consumer goods); and selectively dispense products into the semi-rigid container loaded in the tote 130.

Furthermore, the order fulfillment facility may include an unloading zone, such as: a zone (e.g., a storefront, or a self-service pickup locker system), wherein a customer and/or a delivery worker may retrieve container(s); and/or a zone, wherein a worker may prepare the semi-rigid container for shipment to the customer upon fulfillment. For example, the mobile robotic system 110 can deliver the tote 130 to a delivery conveyor located within the unloading zone, wherein the tote 130 (or the semi-rigid container) may be unloaded and deposited on the delivery conveyor for delivery to a customer retrieval zone (e.g., a storefront). Alternatively, the mobile robotic system 110 can deliver the tote 130 to a pickup locker (e.g., of a self-service pickup locker system), wherein a customer and/or a delivery worker may retrieve the semi-rigid container, or the set of product units within the semi-rigid container, from the tote.

Furthermore, the mobile robotic system 100 can deliver the tote 130 to a staging rack, in a set of staging racks located in the facility, to await retrieval and delivery to an unloading zone by the same or a different mobile robotic system 110. In particular, the tote staging racks can be located in ambient space or in refrigerated enclosures within the facility, such as to maintain cold storage temperatures for chilled or frozen product units. In one example, the mobile robotic system 100 can: implement methods and techniques described below to autonomously fulfill a particular order during a time window (e.g., between 4:00 AM and 4:15 AM) prior to a target fulfillment time (e.g., 8:00 AM) for the order; and deliver the tote 130 to a staging rack prior to the target fulfillment time. Thus, in this example, the order fulfillment system can selectively assign the mobile robotic system 100 to pre-pack the order in advance of high-demand time periods (e.g., between 8:00 AM and 10:00 AM) characterized by relatively-high order demand (or order pickup throughput), without requiring order staging outside of the order fulfillment system.

Accordingly, the mobile robotic system 110 is configured to autonomously facilitate each stage (e.g., retrieving products, dispensing products into containers, delivering containers to pickup locations) of the order fulfillment process. The mobile robotic system 110 can thus reduce waste associated with fulfilling online orders by enabling a customer to retrieve the same container in which products are initially dispensed (e.g., rather than packaging products into a temporary packing container).

### 3.1 Dispensing Units+Optical Sensors

In one application, the mobile robotic system 110 can: access images and/or optical scans, depicting an interior volume of the semi-rigid container, captured by an optical sensor 160 arranged within the dispensing unit 104 and facing the loading zone; and interpret these images and/or optical scans to detect a target location for receiving the product unit within the semi-rigid container.

In particular, the mobile robotic system 110 can detect the target location within the semi-rigid container based on: products extant in the semi-rigid container depicted in these images and/or optical scans; and characteristics (e.g., size, shape, fragility score) of the product type. For example, the mobile robotic system 110 can detect a target location, arranged near a central region of a base of the semi-rigid container (e.g., an empty semi-rigid container), for a canned product. The mobile robotic system 110 can then align the tote 130 to the dispensing unit 104 to receive the canned product near the central region of the base of the semi-rigid container.

### 3.2 Receptacle Geometry+Single-Container System

Generally, the tote 130 can include a receptacle 140 (or a set of receptacles 140) configured to transiently house a semi-rigid container for receiving product units during fulfilment of an order. Alternatively, a mobile robotic system 110 can include a mobile platform 112 and a receptacle 140 arranged above the mobile platform 112 and configured to transiently house a semi-rigid container.

In one application, the receptacle 140 defines a geometry (e.g., size, or shape) compatible with a variety of container types, such as paper bags, plastic bags, reusable tote 130 bags, insulated grocery bags, single-compartment boxes, or multi-compartment boxes. Additionally, the receptacle 140 defines a receptacle angle, such that the receptacle base 142 is arranged below the upward-facing aperture 146. More specifically, the receptacle 140 can be arranged at the receptacle angle, such that a gravitational force is imparted on a product—dispensed proximal the opening of the semi-rigid container—to draw the product downward toward the base of the semi-rigid container.

In this application, the receptacle 140 is configured to locate the semi-rigid container at the receptacle angle to enable products to travel to the bottom of the semi-rigid container at a speed that avoids damaging the product while ensuring the product reaches the target depth within the semi-rigid container.

For example, the receptacle 140 is configured to locate the semi-rigid container at the receptacle angle, such that a fragile item, such as a glass jar, may gently roll into the semi-rigid container without damaging the item or other products extant in the semi-rigid container. More specifically, the receptacle 140 locates the semi-rigid container at the receptacle angle such that, when the glass jar exits the dispensing unit 104, the glass jar initially contacts an inclined surface (i.e., a side) of the semi-rigid container (and the receptacle 140 supporting the semi-rigid container), thereby dissipating a portion of the downward gravitational force (i.e., by redirecting the force along the inclined surface). The receptacle 140 further guides the glass jar to roll along the inclined surface at a controlled speed and trajectory to direct the glass jar toward the lowest position of the semi-rigid container, such as the base or atop another product extant in the semi-rigid container.

Thus, the receptacle 140 locates the semi-rigid container at the receptacle angle to minimize the concentrated force experienced by the glass jar at a point of impact with the receptacle 140, thereby minimizing the risk of breakage to the glass jar. For example, the receptacle 140 minimizes the concentrated force experienced by the glass jar in comparison to the concentrated force experienced by the glass jar responsive to a strictly vertical drop onto the base (i.e., a horizontal surface) of the bag and/or products extant in the semi-rigid container.

In this application, the receptacle 140 is further configured to locate the semi-rigid container at the receptacle angle, such that a product with a relatively high surface area (e.g., a bag of tortillas), or an irregularly-shaped product (e.g., a pineapple) may slide along the lower sidewall of the semi-rigid container without sticking to the lower side. More specifically, the receptacle 140 locates the semi-rigid container at the receptacle angle such that, when a bag of tortillas exits the dispensing unit 104 and contacts the inclined surface of the semi-rigid container, the bag of tortillas overcomes the friction force between the bag of tortillas and the semi-rigid container and slides toward the lowest position within the semi-rigid container. Thus, the receptacle 140 locates the semi-rigid container at the receptacle angle to minimize the friction force experienced by the bag of tortillas, thereby preventing the bag of tortillas from blocking entry of additional products into the interior volume of the semi-rigid container.

In this application, the receptacle 140 is further configured to locate the semi-rigid container at the receptacle angle, such that products, including long or irregularly shaped items (e.g., baguettes or celery stalks), may settle into predictable steady-state locations proximal the lowest position within the semi-rigid container. More specifically, the receptacle 140 locates the semi-rigid container at the receptacle angle, such that gravitational forces guide products toward the lowest-energy position within the semi-rigid container, thereby minimizing uncontrolled movement (e.g., tipping or tilting) of products.

In this application, a relatively elongated product may be positioned within the semi-rigid container parallel to the vertical axis of the semi-rigid container, such that a portion of the elongated product may extend out of the semi-rigid container opening without compromising the stability of the semi-rigid container (i.e., when unloaded from the receptacle 140). For example, the receptacle 140 prevents products from tipping over or shifting unpredictably, which may occur when packing products into a vertically-positioned semi-rigid container. Additionally, the receptacle 140 eliminates the need for manual stabilization during loading (e.g., holding products in place while adding new items). Thus, the receptacle 140 locates the semi-rigid container at the receptacle angle to maintain a stable distribution of product units within the semi-rigid container during packing and transport (i.e., by a customer) of the semi-rigid container.

Accordingly, the receptacle 140 locates the semi-rigid container at the receptacle angle to control the speed and trajectory of products entering the semi-rigid container, thereby: decreasing the risk of damage to products entering the semi-rigid container and/or products extant in the semi-rigid container by dissipating impact forces during product entry; increasing packing stability by directing products to predictable, steady-state positions within the semi-rigid container that minimize tipping, tilting, or shifting during packing and transport; and increasing packing efficiency by preventing products from obstructing the interior volume of the semi-rigid container and arranging products, including long or irregularly shaped items, parallel to the vertical axis of the semi-rigid container.

Furthermore, the receptacle 140 defines a geometry compatible with a variety of container types, thereby: accommodating sustainable container alternatives, such as semi-rigid containers or reusable tote 130 bags; reducing waste associated with repackaging products (e.g., from temporary packing trays); and ensuring efficient and secure packing for a diverse population of products and product constraints (e.g., product shape, product size, product mass, or product fragility).

### 3.3 Container Types

The tote 130 is described herein as configured to transiently house a rigid or semi-rigid container within the receptacle 140. However, the tote 130 can be configured to transiently house various container types, such as semi-rigid containers, hard-sided bins, reusable tote bags, insulated grocery bags, plastic bags, single-compartment boxes, or multi-compartment boxes.

### 4. Terms

A “loading zone” as referred to herein is a zone proximal a dispensing unit 104, wherein product units are dispensed by the dispensing unit 104 into a semi-rigid container loaded into a mobile robotic system 110 occupying the loading zone.

An “unloading zone” is referred to herein as a zone within the order fulfillment facility, wherein totes 130 (i.e., filled totes 130) and/or containers (i.e., filled containers) corresponding to fulfilled (i.e., completed) orders are delivered or deposited by the mobile robotic system 110. In one example, the mobile robotic system 110 can deposit a tote 130 (i.e., a filled tote 130) on a delivery conveyor configured to convey the tote 130 to a “customer retrieval zone” (e.g., a storefront, or a self-service pickup locker system), wherein a customer and/or a delivery worker may retrieve container(s) from the tote 130. Alternatively, the mobile robotic system 110 can maneuver the tote 130 to the customer retrieval zone, rather than delivering the semi-rigid container to the unloading zone, such that a customer and/or a delivery worker may retrieve container(s) directly from the mobile robotic system 110. In another example, the mobile robotic system 110 can deliver a tote 130 to a shipping zone (e.g., a shipping facility), wherein a worker may prepare a container(s) for shipment to a customer.

A “bag loading zone” is referred to herein as a zone within the order fulfillment facility occupied by the mobile robotic system 110, wherein semi-rigid containers can be manually and/or autonomously loaded into receptacles 140.

A “tote pickup zone” is referred to herein as a zone within the order fulfillment facility occupied by the mobile robotic system 110, wherein a mobile platform 112 (i.e., an unloaded platform) can autonomously retrieve a tote 130 (i.e., a loaded tote 130) loaded with a semi-rigid container.

### 5. Mobile Robotic System

In one implementation, as shown in FIGS. 2A and 2B, the mobile robotic system 110 includes: a mobile platform 112 configured to maneuver through an order fulfillment facility; a receptacle 140 arranged over the mobile platform 112 and configured to transiently house a semi-rigid container; and a local controller configured to receive a fulfillment command, associated with a fulfillment order (or an “order”), from the central controller. In particular, the mobile robotic system 110 is configured to: maneuver through the order fulfillment facility to receive product units, dispensed by the set of dispensing units 104, within the semi-rigid container according to the order; and maneuver to an unloading zone for retrieval of the semi-rigid container from the receptacle 140 upon fulfillment (e.g., completion) of the order. In this implementation, rather than retrieving and maneuvering the tote 130 through the order fulfillment facility to receive products, the mobile platform 112 can be configured to receive products directly within a semi-rigid container loaded in the receptacle 140 (e.g., an integrated receptacle 140) and deliver the semi-rigid container to the unloading zone.

In one implementation, the mobile robotic system 110 can: navigate to a loading zone proximal a dispensing unit 104, the dispensing unit 104 loaded with a tray 102, in the population of trays 102, storing product units; and autonomously align the receptacle 140 to the dispensing unit 104 to receive a product unit within the semi-rigid container. For example, the mobile platform 112 can execute: lateral (i.e., front-to-rear, or side-to-side) adjustments; vertical adjustments (e.g., via the elevator 114); and/or rotational adjustments (e.g., via a rotational actuator).

### 5.1 Elevator+Multiple Receptacles

In one variation, the mobile robotic system 110 includes an elevator 114 configured to locate the receptacle 140 over a range of vertical positions. In particular, the elevator 114 can vertically traverse the receptacle 140 to locate the semi-rigid container, loaded in the receptacle 140, to receive a product unit at a target vertical position within the semi-rigid container.

In another variation, the mobile robotic system 110 includes a set of (i.e., two or more) receptacles 140, wherein each receptacle 140 is configured to transiently house a semi-rigid container. In one example, a tote 130 includes: a first receptacle 140 configured to transiently house a first semi-rigid container; and a second receptacle 140, arranged below the first receptacle 140, configured to transiently house a second semi-rigid container. In this example, the elevator 114 can be configured to vertically traverse the first and second receptacles 140 to receive product units within the first and second semi-rigid containers.

### 5.2 Mobile Robotic System With Tote Seat

In one implementation, as shown in FIGS. 1A and 1B, the mobile robotic system 110 includes a mobile platform 112: defining a tote seat 116; and configured to receive a tote 130 at the tote seat 116 and maneuver through the order fulfillment facility to locate the tote 130 proximal the set of dispensing units 104. In particular, the mobile platform 112 defines the tote seat 116: supported on and arranged over the mobile platform 112; and configured to transiently receive the tote 130.

In one implementation, the mobile platform 112 is configured to maneuver to an autonomous tote pickup zone (or “tote pickup zone”), located within the order fulfillment facility, to retrieve a tote 130 loaded with a semi-rigid container. In this implementation, the mobile platform 112 can be configured to engage and transiently retain the tote 130 via engagement features arranged on the mobile platform 112. In particular, the mobile platform 112 can include platform engagement features 118 (e.g., a set of forks, a set of magnets, or a set of clips) configured to engage a set of corresponding tote engagement features (e.g., a set of apertures, a set of magnets, a set of clip-receiving loops) arranged on the tote 130.

In one implementation, the mobile platform 112 is configured to integrate a high precision weighing scale within the tote seat. The high precision weighing scale can measure the mass of dispensed product units, and the mobile robotic system can report the value to a central controller, for the purpose of charging the customer a variable amount of money calculated by multiplying the measured mass of the dispensed product units by a price-per-mass rate.

### 6. Receptacle

The receptacle 140 can include: a receptacle base 142 configured to support the base (e.g., a bottom surface) of the semi-rigid container; one or more receptacle walls 144 extending from the receptacle base 142 and configured to support one or more sides (e.g., left, right, front, or back sides) of the semi-rigid container; and an upward-facing aperture 146 aligned to an opening of the semi-rigid container to permit passage of product units into the semi-rigid container. In one variation, the receptacle 140 can include a side-facing aperture that cooperates with the upward-facing aperture 146 to maintain access to the interior volume of the receptacle 140.

### 6.1 Receptacle Angle

In one implementation, the receptacle 140 can be arranged at a receptacle angle, such that the receptacle base 142 is arranged below the upward-facing aperture 146. More specifically, the receptacle 140 can be arranged at the receptacle angle, such that a gravitational force is imparted on a product—dispensed proximal the opening of the semi-rigid container—to draw the product downward toward the base of the semi-rigid container.

In particular, a semi-rigid container can: define an interior volume exhibiting a geometry when the semi-rigid container is in an expanded position; be configured to locate within the receptacle 140 at the receptacle angle; and include a semi-rigid material configured to partially maintain the geometry of the interior volume when the semi-rigid container is located within the receptacle 140 in the expanded position and at the receptacle angle. Furthermore, the semi-rigid container can include: a base configured to seat against the receptacle base 142; an upper sidewall (e.g., located proximal the upper receptacle wall 144 when the semi-rigid container is loaded in the angled receptacle 140); a lower sidewall (e.g., located proximal the lower receptacle wall 144 when the semi-rigid container is loaded in the angled receptacle 140); and a pair of sidewalls interposed between the upper sidewall and the lower sidewall. In particular, the pair of sidewalls are configured to deform along fold lines to transition the semi-rigid container from a collapsed position to the expanded position. Thus, when located at an angle, the semi-rigid container may collapse or buckle during product loading absent a support to the base and lower sidewall.

In one implementation, the receptacle 140 is configured to: support the lower sidewall of the semi-rigid container at the receptacle angle, angularly offset from a horizontal plane by a pitch offset; and support a base of the semi-rigid container. In particular, the receptacle 140 includes: a base; a lower receptacle wall 144 extending from the receptacle base 142 and configured to support the lower sidewall of the semi-rigid container at the receptacle angle (e.g., between 10 degrees and 45 degrees); and an upper receptacle wall 144, opposite the lower receptacle wall 144, extending from the receptacle base 142.

More specifically, the central controller selects the target unoccupied subvolume (e.g., an unoccupied subvolume) for an incoming product unit based on a geometry of the first product type and the geometry of the interior volume when the semi-rigid container is in the expanded position. Thus, if the real geometry of the interior volume deviates from the nominal geometry—due to collapse, buckling, or deformation of one or more sidewalls—the selected target position does not accurately correspond to a viable position within the interior volume. Accordingly, the lower receptacle wall 144 is configured to support the lower sidewall of the semi-rigid container to maintain the geometry of the interior volume during dispensation of a product unit into the semi-rigid container, such that the product unit can travel (e.g., roll or slide) along the lower sidewall under gravitational force toward the target unoccupied subvolume.

Furthermore, the sidewall retainer 150 is configured to retain the upper sidewall of the semi-rigid container to constrain deformation of the pair of sidewalls and maintain the semi-rigid container in the expanded position to permit passage of the product unit into the semi-rigid container. Accordingly, the receptacle 140 is configured to support the lower sidewall of the semi-rigid container and tension the upper sidewall of the semi-rigid container to maintain the expanded geometry of the interior volume, prevent collapse of the pair of sidewalls, and preserve an unobstructed opening for successive product units.

Furthermore, the receptacle 140 is configured to locate the semi-rigid container at the receptacle angle such that the base of the semi-rigid container is arranged below the opening of the semi-rigid container. For example, the receptacle 140 can be arranged at a receptacle angle between 10 degrees and 45 degrees. In particular, the receptacle 140 is configured to: receive a product unit, dispensed by a dispensing unit 104, through the upward-facing aperture 146; and direct the product unit along the lower sidewall of the semi-rigid container, arranged at the receptacle angle, and toward the base of the semi-rigid container to locate the product unit in a target unoccupied subvolume selected for the product unit. More specifically, the mobile robotic system 110 can locate the receptacle 140 proximal a dispensing unit 104, and the dispensing unit 104 can then dispense a product proximal the opening of the semi-rigid container such that the product may roll or slide downward into the semi-rigid container (i.e., toward the base), guided by the receptacle angle.

Thus, the receptacle 140 can be arranged at a receptacle angle such that products, dispensed by a dispensing unit 104 proximal the opening of the semi-rigid container, can gently roll or slide into the semi-rigid container. More specifically, the receptacle angle enables controlled entry of products into the semi-rigid container, thereby preventing: a product from rapidly dropping (e.g., vertically dropping) into the semi-rigid container, which may damage the product and/or products extant in the semi-rigid container; and/or a product from sticking to a sidewall of the semi-rigid container due to lack of sufficient gravitational forces drawing the product toward the base, which may decrease packing efficiency.

### 6.2 Sidewall Retainer

In one implementation, the mobile robotic system 110 includes a sidewall retainer 150 configured to retain the upper sidewall (i.e., an upper sidewall of the semi-rigid container when loaded in the receptacle 140) of the semi-rigid container to maintain access to an interior volume of the semi-rigid container and permit passage of product units into the semi-rigid container. For example, the sidewall retainer 150 can include: a set of mechanical spring-loaded clips; and/or a set of vacuum ports coupled to a vacuum pump arranged in the mobile robotic system 110. In particular, the sidewall retainer 150 is configured to retain the upper sidewall of the semi-rigid container to prevent the upper sidewall from collapsing and obstructing the opening of the semi-rigid container during dispensation of product units into the semi-rigid container.

In one implementation, the sidewall retainer 150 is configured to: retain the upper sidewall of the semi-rigid container against the upper receptacle wall 144 when the semi-rigid container occupies the receptacle 140 at the receptacle angle; and release the upper sidewall of the semi-rigid container for removal of the semi-rigid container from the receptacle 140. Accordingly, the sidewall retainer 150: prevents collapse and obstruction of the opening of the semi-rigid container during product loading; and permits unobstructed removal of the semi-rigid container from the receptacle 140 when the order is fulfilled.

In one variation, the mobile robotic system 110 further includes a sidewall retainer 150 (e.g., mechanical spring-loaded clips, vacuum ports) configured to retain the lower sidewall of the semi-rigid container to prevent the lower sidewall from buckling during dispensation of product units into the semi-rigid container.

### 6.2.1 Sidewall-Retaining Clips

In one example, the mobile robotic system 110 includes a set of clips 150 configured to transiently secure the semi-rigid container within the receptacle 140. In particular, the set of clips 150 can be arranged proximal the upward-facing aperture 146 and configured to transition between a disengaged (i.e., closed) position and an engaged (i.e., open) position. More specifically, in the disengaged position, the set of clips 150 can be configured to disengage or release the sides of the semi-rigid container for addition and/or removal of the semi-rigid container from the receptacle 140, such as during customer retrieval. Conversely, in the engaged position, the set of clips 150 can be configured to engage (e.g., pinch) the sides of a semi-rigid container to secure the semi-rigid container within the receptacle 140 and maintain the semi-rigid container in the expanded (i.e., opened) position.

The set of clips 150 can be arranged proximal the upward-facing aperture 146 to secure the sides of the semi-rigid container proximal the opening of the semi-rigid container. In one example, the set of clips 150 includes a set of (i.e., one or more) clips 150 arranged proximal a distal edge (e.g., an upper edge) of an upper receptacle wall 144 and configured to secure an upper sidewall of the semi-rigid container. In this example, the set of clips 150 can: retain the upper sidewall of the semi-rigid container against the upper receptacle wall 144 in the engaged position; and release the upper sidewall of the semi-rigid container in the disengaged position. In another example, the set of clips 150 includes: a first set of (i.e., one or more) clips arranged proximal a first distal edge (e.g., an upper edge) of the upper receptacle wall 144 and configured to secure an upper sidewall of the semi-rigid container; and a second set of clips 150 arranged proximal a second distal edge (e.g., a lower edge) of the lower receptacle wall 144 and configured to secure a lower sidewall of the semi-rigid container.

In one configuration, wherein the receptacle 140 is loaded with a semi-rigid container, the first set of clips 150 is configured to secure the upper sidewall of the semi-rigid container to prevent the upper sidewall from collapsing toward the lower sidewall of the semi-rigid container and obstructing the opening of the semi-rigid container. Additionally, in this configuration, the second set of clips 150 is configured to secure the lower sidewall of the semi-rigid container to prevent the lower sidewall from collapsing into the receptacle 140 toward the receptacle base 142 when products slide over the lower sidewall, thereby reducing available container volume and/or risking tearing to the sides of the semi-rigid container. Therefore, the set of clips 150 can secure the semi-rigid container within the receptacle 140 and prevent collapses or tears that may hinder the loading or retrieval of products.

### 6.3 Receptacle Geometry

The receptacle 140 can define a geometry (e.g., size, or shape) compatible with a variety of container types, such as semi-rigid containers, plastic bags, reusable tote 130 bags, insulated grocery bags, single-compartment boxes, or multi-compartment boxes. For example, the receptacle 140 can define a total volume approximating (or slightly larger than) a semi-rigid container volume: to maximize product storage and ensure efficient packing of the available receptacle 140 volume while securely retaining the semi-rigid container; to minimize excess space around the semi-rigid container, thereby preventing excessive movement (e.g., shifting or tipping) of products within the semi-rigid container; and to facilitate efficient (e.g., manual or autonomous) container loading. The receptacle 140 can thus be configured to transiently house a variety of container types and/or container sizes to accommodate a variety of product constraints (e.g., product shape, product size, or product fragility) and/or facility preferences (e.g., a semi-rigid container type preferred by a particular grocery store).

### 7. Tote

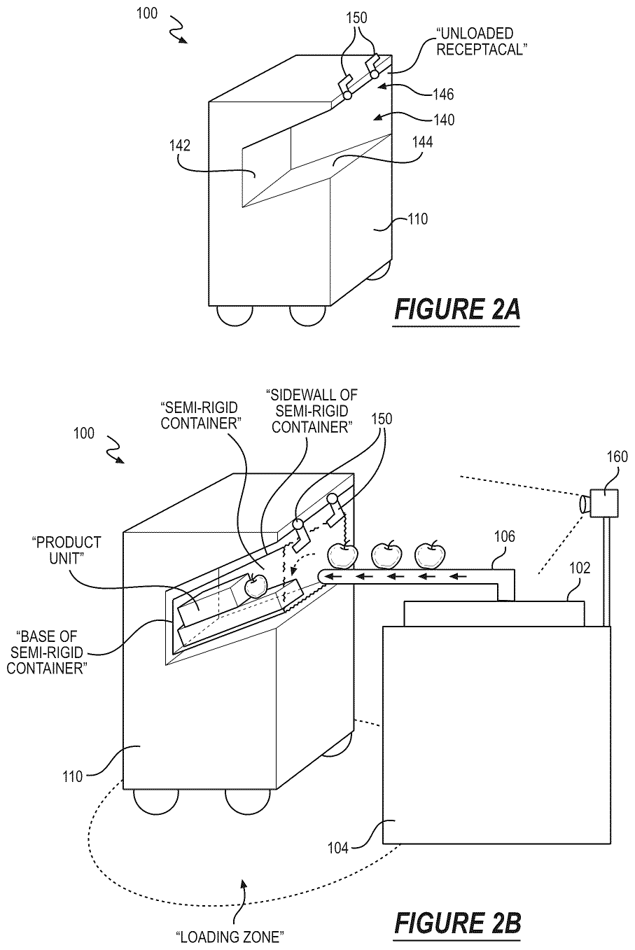

In one implementation, as shown in FIGS. 1A, 1B, and 3, the order fulfillment system 100 includes a set of totes 130. Each tote 130, in the set of totes 130, can be configured to transiently mount on the tote seat 116 of the mobile platform 112 and receive products dispensed by the dispensing units 104. In particular, the tote 130 can define a receptacle 140 configured to transiently receive and support a semi-rigid container in an expanded (i.e., opened) position for receiving products. In one variation, the tote 130 defines a set of (i.e., two or more) receptacles 140, wherein each receptacle 140 is configured to transiently house a semi-rigid container.

### 8. Bag Dispenser+Bag Loader

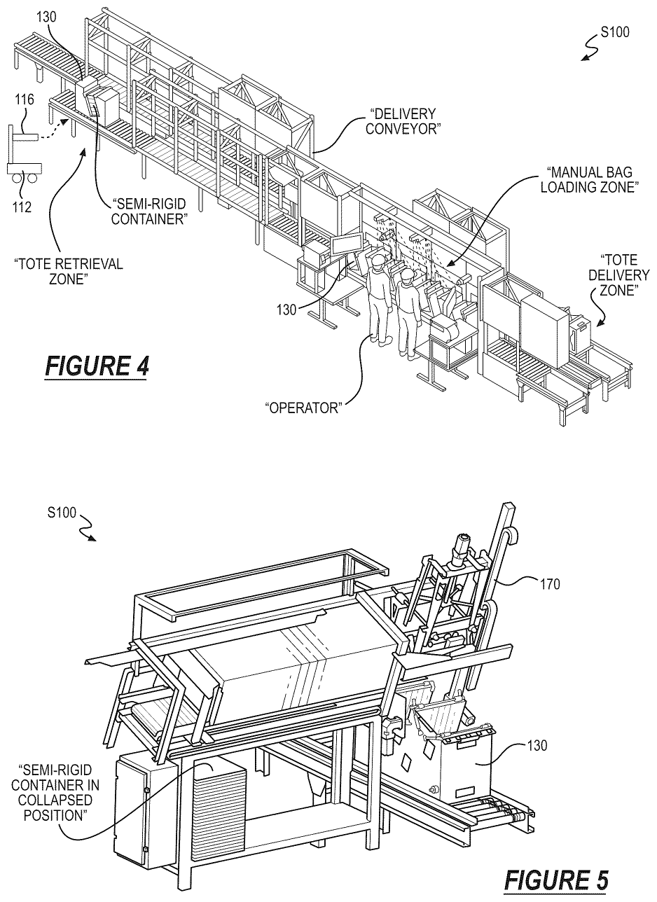

In one variation, as shown in FIG. 5, the order fulfillment system 100 includes: a bag dispenser configured to dispense a semi-rigid container in a collapsed (i.e., closed or flattened) position; and a bag loader 170 configured to load bags into receptacles 140. In particular, the bag loader 170 is configured to: transition the semi-rigid container from the collapsed position to the expanded position; and load the semi-rigid container, in the expanded position, into the receptacle 140, along the center axis, to seat the base of the semi-rigid container against the receptacle base 142 of the receptacle 140.

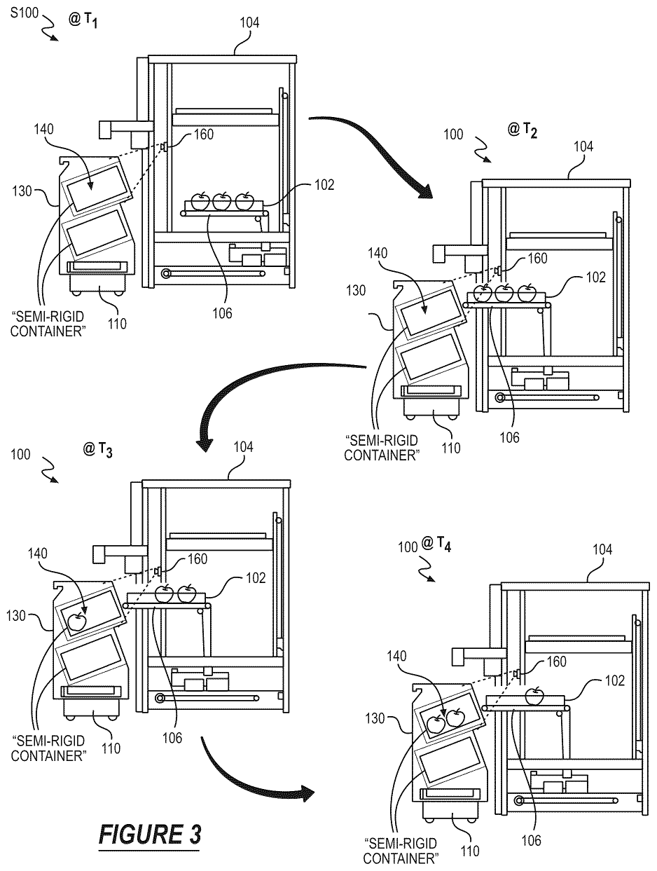

Additionally or alternatively, the order fulfillment system 100 can include a manual bag loading zone, wherein an operator may manually load the semi-rigid container, in the expanded position, into the receptacle 140. For example, as shown in FIG. 4, the order fulfillment system 100 can include a conveyor configured to traverse unloaded totes 130 past the manual bag loading zone and locate loaded totes 130 proximal the tote pickup zone for retrieval by a mobile robotic system 110.

### 9. Storage Racks and Trays

In one implementation, the order fulfillment system 100 includes: a population of trays 102 configured to transiently store product units; and a set of storage racks configured to transiently store the population of trays 102. In particular, the set of storage racks define a corpus of slots, each slot in the corpus of slots configured to store an individual tray 102 in the population of trays 102. Each tray 102 in the population of trays 102 is loaded with product units, such as product units of a single product type or product units of multiple product types, and configured to transiently store within a slot in the corpus of slots of the set of storage racks. Each tray 102 in the population of trays 102 includes an opening and a set of supports, the set of supports: defining a set of lanes within the tray 102; and configured to support rows of product units within the set of lanes.

### 10. Dispensing Units

In one implementation, as shown in FIG. 3, the order fulfillment system 100 includes a set of dispensing units 104 configured to transiently receive the population of trays 102 and dispense product units transiently stored within the population of trays 102. In particular, each dispensing unit 104 in the set of dispensing units 104 faces a loading zone and is configured to: receive a tray 102 in the population of trays 102; and selectively dispense individual product units from the tray 102 toward the loading zone. Each dispensing unit 104 in the set of dispensing units 104 includes a set of dispensing arms 106 configured to: pass through an opening of the tray 102 toward the set of supports; elevate through a lane defined between a pair of supports in the set of supports to lift a row of product units, stored in the lane between the pair of supports, above the lane; and drive the row of product units forward toward the loading zone.

Each dispensing unit 104 in the set of dispensing units 104 further includes an optical sensor 160 (e.g., a color camera, a LIDAR sensor, a depth sensor, a two-dimensional camera, or a three-dimensional camera) facing the loading zone. In particular, the optical sensor 160: is arranged proximal a front side (e.g., proximal the loading zone) of the dispensing unit 104; and defines a field of view intersecting the loading zone. The optical sensor 160 is configured to capture images (e.g., two-dimensional color images, stereoscopic color images, depth maps) representing objects and surfaces of: the semi-rigid container (e.g., the base or sides of the semi-rigid container); and/or product units contained within the semi-rigid container loaded in the receptacle 140. More specifically, the optical sensor 160: is arranged at an angle angularly offset from the horizontal plane; and defines a field of view intersecting the interior volume of the semi-rigid container when the mobile robotic system 110 occupies the loading zone.

In one variation, each dispensing unit 104 in the set of dispensing units 104 further includes an optical sensor 160 (e.g., a color camera, a LIDAR sensor, a depth sensor, a two-dimensional camera, or a three-dimensional camera) facing the tray 102 loaded into the dispensing unit 104. In this variation, the optical sensor 160 is configured to capture images (e.g., two-dimensional color images, stereoscopic color images, depth maps) representing objects and surfaces of product units transiently stored within the tray 102. In this variation, the central controller can interpret these images to detect a product type and/or a quantity of product units transiently stored within each lane of the tray 102.

### 11. Tray-Routing System

In one implementation, the order fulfillment system 100 includes a tray-routing system configured to transfer the population of trays 102 between the set of storage racks and the set of dispensing units 104. In particular, the tray-routing system is configured to: retrieve a tray 102 from a slot in the corpus of slots of the storage rack; and maneuver the tray 102 through a tray-routing network to locate the tray 102 within a dispensing unit 104, in the set of dispensing units 104, assigned to the tray 102 for dispensation of product units transiently stored in the tray 102.

The tray-routing system is further configured to: retrieve the tray 102 from the dispensing unit 104; and maneuver the tray 102 through the tray-routing network to locate the tray 102 within the slot for temporary storage of the tray 102.

In one example, the tray-routing system can include a network of conveyors and a miniload crane, the miniload crane configured to: retrieve a tray 102 from a slot in the corpus of slots of the storage rack; and deliver the tray 102 to the network of tray 102 conveyors. In this example, the network of conveyors is configured to maneuver the tray 102 to locate the tray 102 within a dispensing unit 104, in the set of dispensing units 104, assigned to the tray 102 for dispensation of product units transiently stored in the tray 102.

### 12. Central Controller

In one implementation, the order fulfillment system 100 includes a central controller (e.g., a local controller or a remote controller) configured to trigger actions by the set of dispensing units 104, tray-routing system, the bag loader 170, and the mobile robotic system 110.

### 13. Order Fulfillment: Mobile Robotic System With Integrated Receptacle

Blocks of the method S100 recite: receiving a fulfillment order specifying a quantity of product units of a product type in Block S110; identifying a tray 102, in a population of trays 102, transiently storing product units of the product type in Block S112; and assigning a dispensing unit 104, in a set of dispensing units 104, for dispensation of product units transiently stored in the tray 102 in Block S114. Generally, as shown in FIG. 6, the central controller can: receive an order specifying a list of product types; trigger the mobile robotic system 110 (i.e., loaded with a semi-rigid container) to maneuver through the order fulfillment facility to fulfill the order; and trigger the mobile robotic system 110 to maneuver to an unloading zone for removal of the semi-rigid container from the receptacle 140. Then, in response to receiving a new order, the central controller can trigger the mobile robotic system 110 (i.e., devoid of a semi-rigid container) to maneuver to the bag loader 170 to receive a new semi-rigid container.

In one implementation, the central controller can: receive a fulfillment order specifying a quantity of product units of a product type; and identify the tray 102, in the population of trays 102, transiently storing product units of the product type. The central controller can then generate a fulfillment command associated with the fulfillment order and specifying: the mobile robotic system 110; the tray 102; the dispensing unit 104; and dispensation of the quantity of product units of the product type. The central controller can then disseminate the fulfillment command to the mobile robotic system 110.

In one implementation, the crane controller can: receive an order specifying product units of product types; identify a tray 102, in the population of trays 102, transiently storing product units of a product type specified in the order; assign a dispensing unit 104 for dispensation of the product unit transiently stored in the tray 102; trigger the mobile robotic system 110 to navigate to a loading zone proximal the dispensing unit 104; trigger the mobile robotic system 110 to maneuver within the loading zone to locate the semi-rigid container to receive the product unit at a target unoccupied subvolume within the semi-rigid container; and trigger the dispensing unit 104 to dispense the product unit into the semi-rigid container.

### 13.1 Target Product Position Selection

In one variation, Blocks of the method S100 recite: accessing an image, depicting an interior volume of the semi-rigid container, captured by an optical sensor 160 arranged within the dispensing unit 104 and facing the loading zone in Block S130; accessing a set of characteristics (e.g., size, shape, mass, fragility score) of the product type in Block S132; and selecting a target unoccupied subvolume for receiving the product unit within the semi-rigid container based on the image and the set of characteristics of the product type in Block S140.

In this variation, the central controller can interpret images and/or optical scans of the interior volume of the semi-rigid container to select the target unoccupied subvolume for receiving the product unit within the semi-rigid container. In particular, in this variation, when the mobile robotic system 110 occupies the loading zone proximal a dispensing unit 104, the central controller can access an image—captured by the optical sensor 160 arranged at the dispensing unit 104—depicting the interior volume of the semi-rigid container. The central controller can then: access a set of characteristics (e.g., geometry, dimensions, mass, fragility score) of a product type of a product unit assigned for dispensation at the dispensing unit 104; and select the target unoccupied subvolume for the product unit based on the image and the set of characteristics of the product type. More specifically, the central controller can: detect an unoccupied volume within the semi-rigid container based on the image; and select the target unoccupied subvolume for the product unit, the target unoccupied subvolume compatible with the set of characteristics of the product type.

The central controller can then trigger the mobile robotic system 110 to execute adjustment maneuvers (e.g., vertical adjustments, lateral adjustments) to locate the semi-rigid container to receive the product unit at the target unoccupied subvolume within the semi-rigid container. For example, the central controller can: generate an adjustment command specifying the target location; and transmit the adjustment command to the mobile robotic system 110 to align the receptacle 140 with the dispensing unit 104 to receive the product unit in the target location within the semi-rigid container.

In one variation, the central controller can: access an image captured by the optical sensor 160 and depicting extant product units occupying the interior volume of the semi-rigid container; detect an unoccupied volume within the semi-rigid container based on the image; access a geometry of a product type of the product unit (i.e., assigned for dispense by the dispensing unit 104); and select a target position for receiving the product unit within the semi-rigid container, the target unoccupied subvolume encompassing the geometry of the product type.

In another variation, the central controller can: access the image depicting an extant (i.e., previously-retrieved) product unit of a first product type contained within the interior volume of the semi-rigid container; access a first set of characteristics (e.g., size, shape, mass, fragility score) of the first product type; access a second set of characteristics (e.g., size, shape, mass, fragility score) of a second product type of a second product unit; and select the target unoccupied subvolume for the second product unit of the second product type based on the image, the first set of characteristics of the first product type, and the second set of characteristics of the second product type.

For example, the central controller can: access an image depicting a glass jar of olives contained within the interior volume of the semi-rigid container; and detect a target location within the semi-rigid container for a glass jar of pickles that minimizes the risk of damage (e.g., caused by a glass-on-glass interaction) to the glass jar of olives and the glass jar of pickles during dispensation of the glass jar of pickles. Therefore, the central controller can select the target unoccupied subvolume for each product unit based on images captured at each dispensing unit 104, such as to: maximize packing efficiency within the semi-rigid container; and/or prevent damage to extant product units occupying the semi-rigid container.

### 13.1.1 Simulated Product Placement

In one variation, the central controller can simulate virtual positions within the semi-rigid container for an incoming product unit, such as to maximize packing density of the semi-rigid container. In this variation, the central controller can: trigger the mobile robotic system 110 to navigate to a loading zone proximal a dispensing unit 104 to receive a product unit of a product type specified in an order; and detect an unoccupied volume within the semi-rigid container when the mobile robotic system 110 occupies the dispensing unit 104 based on an image captured by the optical sensor 160 arranged at the dispensing unit 104. The central controller can then simulate a population of virtual product configurations, each virtual product configuration representing a virtual target unoccupied subvolume for a virtual product unit of the product type.

In particular, the central controller can: generate a virtual semi-rigid container representing a virtual unoccupied volume within the virtual semi-rigid container with the virtual semi-rigid container in a virtual angled position based on the image; and simulate a population of virtual product configurations within the virtual semi-rigid container, each virtual product configuration representing a virtual product unit of a first product type of the first product unit occupying a virtual unoccupied subvolume in the virtual unoccupied volume. More specifically, the central controller can simulate a population of virtual product unit orientations at various virtual positions within the virtual semi-rigid container that are compatible with the geometry and/or dimensions of the virtual product unit.

For each virtual product position, the central controller can calculate a virtual packing density of a virtual semi-rigid container, loaded with a virtual product unit at a virtual product position, based on: a total occupied subvolume of the virtual semi-rigid container occupied by virtual product units; and a remaining unoccupied subvolume of the virtual semi-rigid container (e.g., available for loading additional product units). The central controller can then: converge on a first virtual product configuration, in the population of virtual product configurations, corresponding to a first virtual semi-rigid container exhibiting a maximum virtual packing density and loaded with the virtual product unit occupying a first virtual unoccupied subvolume; and select a target unoccupied subvolume, coincident with the virtual target unoccupied subvolume, for the product unit. Therefore, by simulating a range of virtual product positions prior to dispensation, the central controller can accurately predict a target unoccupied subvolume that yields the highest achievable packing density for the semi-rigid container.

In another variation, the central controller can simulate virtual positions within the semi-rigid container for an incoming product unit, such as to maintain upright stability when the semi-rigid container is transitioned to an upright orientation. In this variation, the central controller can: implement methods and techniques described above to simulate a population of virtual product configurations for a virtual product unit within the virtual semi-rigid container; and, for each virtual product position, calculate a virtual center of mass of a virtual semi-rigid container, loaded with a virtual product unit at a virtual target unoccupied subvolume and in a virtual upright position. In particular, the central controller can calculate the virtual center of mass of the virtual semi-rigid container based on: a geometry of the product type; a mass of the product type; and an estimated virtual position of the virtual product unit when the virtual semi-rigid container transitions to the virtual upright position.

Additionally, the central controller can: access characteristics (e.g., geometries, masses, weight distributions) of product types of extant product units occupying the semi-rigid container; and calculate the virtual center of mass of the virtual semi-rigid container based on these characteristics. The central controller can then: converge on a first virtual product configuration, in the population of virtual product configurations, corresponding to a first virtual semi-rigid container exhibiting a lowest center of mass and loaded with the virtual product unit occupying a first virtual unoccupied subvolume; and select the target unoccupied subvolume, coincident with the virtual target unoccupied subvolume, for the product unit. For example, the central controller can simulate placement of a first dense product unit (e.g., a glass bottle) within a lower region of the semi-rigid container and a second lightweight product unit (e.g., a bag of chips) above the first dense product unit, such that the resulting virtual semi-rigid container exhibits a reduced center of mass and improved upright stability during handling. Therefore, the central controller can predict a target unoccupied subvolume that yields a minimum center of mass for the semi-rigid container, thereby maintaining product stability and preventing tilting or collapse when the semi-rigid container is transitioned from an angled position within the receptacle 140 to the upright position.

In another variation, the central controller can simulate physical interactions between virtual product units within the virtual semi-rigid container to predict and avoid potential product damage during loading. In this variation, the central controller can simulate kinematic behaviors of virtual product units (e.g., via a virtual physics model), such as translation, rotation, and collision responses, based on material and geometric properties of these product units. For each virtual product configuration, the central controller can: calculate contact forces, deformation characteristics, and surface friction effects between adjacent virtual product units and interior surfaces of the virtual semi-rigid container; and identify configurations predicted to minimize excessive compression, impact, or abrasion that may damage delicate product units. Furthermore, the central controller can simulate accurate size, shape, and mass distributions of the virtual product units to reflect real-world interactions, thereby enabling the central controller to select a target unoccupied subvolume predicted to maintain structural integrity of the products and prevent damage during loading and transport.

In one variation, the local controller can implement methods and techniques described above to access an image depicting the interior volume of the semi-rigid container (and extant product units within the interior volume); and implement methods and techniques described above to select the target unoccupied subvolume for the product unit based on the image.

### 13.2 Local Maneuvers at Dispensing Unit+Autonomous Product Retrieval

Blocks of the method S100 recite: triggering the mobile platform 112 to align the receptacle 140 to the dispensing unit 104 to receive a product unit in the target unoccupied subvolume in Block S122; and triggering the dispensing unit 104 to dispense the product unit into the semi-rigid container loaded into the mobile robotic system 110 occupying the loading zone in Block S150.

In one implementation, the mobile robotic system 110 can autonomously align the receptacle 140 to the dispensing unit 104 to receive a product unit at a target unoccupied subvolume within the semi-rigid container. For example, the mobile platform 112 can execute: lateral (i.e., front-to-rear, or side-to-side) adjustments; vertical adjustments (e.g., via the elevator 114); and/or rotational adjustments (e.g., via a rotational actuator).

In one example, each dispensing unit 104, in the set of dispensing units 104, can include a set of dispensing arms 106 configured to: lift a row of product units, stored in the tray 102, above the tray 102 when the tray 102 is loaded in the dispensing unit 104; and drive the row of product units forward to dispense product units toward the loading zone. In particular, the set of dispensing arms 106 are configured to: elevate through a lane of the tray 102, the lane storing a row of product units of a product type specified in the order and arranged at a lateral position within the tray 102; lift the row of product units, above the tray 102, to a dispense height; and drive the row of product units forward to dispense product units from the row of product units.

Additionally, the controller can select a target vertical offset between the set of dispensing arms and the first sidewall of the semi-rigid container that: avoids damage to the product unit during dispense of the product unit from the set of dispensing arms toward the sidewall of the semi-rigid container; and yields controlled descent of the product unit along the sidewall of the semi-rigid container, supported at the angle, toward a target lateral position, a target vertical position, and a target depth (e.g., of the target unoccupied subvolume). The controller can then select a target longitudinal position of the set of dispensing arms based on the target vertical offset.

In this example, the mobile robotic system 110 can: laterally maneuver the receptacle 140, via the mobile platform 112, to align the semi-rigid container to the set of dispensing arms 106 to receive a product unit at a target lateral position; and vertically maneuver the receptacle 140, via the elevator 114, to locate the semi-rigid container proximal the set of dispensing arms 106 to receive the product unit at a target vertical position. More specifically, the mobile robotic system 110 can: laterally maneuver the receptacle 140 to align the semi-rigid container to the lateral position of the lane of the tray 102 to receive a product unit at the target lateral position; and vertically maneuver the receptacle 140, based on the dispense height, to locate the semi-rigid container to receive the product unit at the target vertical position.

Once the mobile robotic system 110 aligns the semi-rigid container to the dispensing unit 104, the central controller can trigger the set of dispensing arms 106 to: lift a row of product units of the product type, transiently stored in the tray, above the tray 102; drive horizontally toward the target longitudinal position to extend into the interior volume of the semi-rigid container and over the sidewall of the semi-rigid container at the target vertical offset; and drive the row of product units forward to dispense the product unit into the semi-rigid container. Thus, the mobile robotic system 110 executes local maneuvers within the loading zone proximal the dispensing unit 104 to align the semi-rigid container with the dispensing trajectory, such that each product unit is received at the selected target unoccupied subvolume within the semi-rigid container.

### 13.3 Multi-Product Dispense+Local Maneuvers at Dispensing Unit

In one variation, the mobile robotic system 110 can execute local maneuvers at the dispensing unit 104 during dispensation of multiple product units (i.e., by a single dispensing unit 104) into the semi-rigid container. In this variation, the central controller can: receive an order specifying a first product type and a second product type; identify a tray 102, in the population of trays 102, transiently storing product units of the first product type and product units of the second product type; and trigger the mobile robotic system 110 to navigate to a dispensing unit 104 assigned for dispensation of product units from the tray 102.

The central controller can then implement methods and techniques described above to: trigger the optical sensor 160 to capture a first image when the mobile robotic system 110 occupies the first loading zone; select a first target unoccupied subvolume for a first product unit of the first product type based on the first image; trigger the mobile robotic system 110 to execute local maneuvers to align the semi-rigid container to receive the first product unit at the first target unoccupied subvolume; and trigger the dispensing unit 104 to dispense the first product unit into the semi-rigid container. The central controller can then: trigger the optical sensor 160 to capture a second image following dispensation of the first product unit into the semi-rigid container; detect an unoccupied volume within the semi-rigid container based on the second image; and select a second target unoccupied subvolume for receiving the second product unit within the semi-rigid container.

In one example, the central controller can: select the first target unoccupied subvolume for receiving the first product unit within the semi-rigid container based on a first image captured by the optical sensor 160, the first image depicting absence of product units occupying the interior volume of the semi-rigid container; trigger the optical sensor 160 to capture a second image following dispensation of the first product unit into the semi-rigid container; detect a first real position of the first product unit within the semi-rigid container based on the second image, the first real position deviating from the first target unoccupied subvolume; and select a second target unoccupied subvolume for receiving the second product unit within the semi-rigid container based on the first real position of the first product unit. Thus, in this example, the central controller corrects for deviations between expected and actual product positions to select accurate target positions for subsequent product units.

Additionally, in this example, the central controller can trigger the mobile robotic system 110 to execute local maneuvers based on the second target unoccupied subvolume. For example, the central controller can select: a second target lateral position for a second product unit, the second target lateral position adjacent a first target lateral position for a first product unit; and a second target vertical position for the second product unit, the second target vertical position above a first target vertical position for the first product unit. The central controller can then trigger the mobile robotic system 110 to: laterally maneuver the receptacle 140 to align the semi-rigid container to the set of dispensing arms 106 to receive the second product unit at the second target lateral position; and vertically maneuver the receptacle 140 to locate the semi-rigid container proximal the set of dispensing arms 106 to receive the second product unit at the second target vertical position. Additionally, the central controller can trigger the set of dispensing arms 106 to: lift a second row of product units of the second product type, adjacent the first row of product units in the tray 102, above the tray 102; and drive the second row of product units forward to dispense the second product unit into the semi-rigid container.

In another variation, the mobile robotic system 110 can navigate through the order fulfillment facility to retrieve product units from multiple dispensing units 104. In this variation, the central controller can: receive an order specifying a first product type and a second product type; assign a first dispensing unit 104 to dispense a first product unit of the first product type from a first tray 102; trigger the mobile robotic system 110 to navigate to a first loading zone proximal the first dispensing unit 104; and access a first image captured by a first optical sensor 160, arranged at the first dispensing unit 104, and depicting the interior volume of the semi-rigid container. The central controller can then: select the first target unoccupied subvolume for receiving the first product unit within the semi-rigid container based on the first image; trigger the mobile robotic system 110 to execute local maneuvers to align the semi-rigid container to receive the first product unit at the first target unoccupied subvolume; and trigger the dispensing unit 104 to dispense the first product unit into the semi-rigid container.

The central controller can then: assign a second dispensing unit 104 to dispense a second product unit of the second product type from a second tray 102; trigger the mobile robotic system 110 to navigate to a second loading zone proximal a second dispensing unit 104; and access a second image captured by a second optical sensor 160 arranged at the second dispensing unit 104. In particular, the central controller can: access the second image depicting the first product unit occupying the interior volume of the semi-rigid container; select a second target unoccupied subvolume for receiving the second product unit within the semi-rigid container based on the second image, the second target unoccupied subvolume arranged above the first target unoccupied subvolume; trigger the mobile robotic system 110 to vertically maneuver the receptacle 140 to locate the semi-rigid container to receive the second product unit at the second target unoccupied subvolume; and trigger the second dispensing unit 104 to dispense the second product unit into the semi-rigid container. Thus, the central controller executes on-demand imaging at each dispensing unit 104 to adapt target positioning for each individual product unit as the mobile robotic system 110 navigates to different dispensing units 104 to retrieve product units.

### 13.4 Order Completion+Semi-Rigid Container Removal

Block S124 of the method S100 recites triggering the mobile robotic system 110 to navigate to an unloading zone within the order fulfillment facility. Generally, upon fulfillment of an order, the mobile robotic system 110 can navigate to an unloading zone for removal (e.g., manual removal, autonomous removal) of the semi-rigid container from the receptacle 140. For example, the central controller can trigger the mobile robotic system 110 to: navigate to the unloading zone for retrieval of the semi-rigid container, loaded with a set of product units, from the receptacle 140; and, in response to detecting a location of the mobile robotic system 110 approaching the unloading zone, trigger the sidewall retainer 150 (e.g., a set of clips) to disengage the upper sidewall of the semi-rigid container.

In one example, the mobile robotic system 110 can maneuver to the unloading zone, wherein the semi-rigid container may be: manually unloaded (e.g., via a worker) from the receptacle 140 and deposited on a delivery conveyor (i.e., for delivery to the customer retrieval zone); and/or autonomously unloaded (e.g., via an autonomous container unloader) from the receptacle 140 and deposited on the delivery conveyor.

In another example, the mobile robotic system 110 can: maneuver through the order fulfillment facility to locate the receptacle 140 proximal a dispensing unit 104 to receive products within the semi-rigid container transiently housed within the receptacle 140; and maneuver to a customer retrieval zone, wherein a customer and/or a delivery worker may retrieve the semi-rigid container directly from the receptacle 140. Thus, the mobile robotic system 110 can receive, transport, and deliver products directly within the receptacle 140 (e.g., rather than retrieving, filling, and delivering a tote 130).

In one variation, upon removal or retrieval of the semi-rigid container from the receptacle 140, the mobile robotic system 110 can navigate to the bag loader 170 to receive a new semi-rigid container for autonomously fulfilling a new order. In particular, in this variation, the central controller can: in response to completion of a first order, trigger the mobile robotic system 110 to navigate to the unloading zone for removal of a first semi-rigid container, loaded with product units, from the receptacle 140; and, in response to removal of the first semi-rigid container from the receptacle 140, trigger the mobile robotic system 110 to navigate to the bag loader 170. The central controller can then: trigger the bag loader 170 to transition a second semi-rigid container from a collapsed position to an expanded position; trigger the bag loader 170 to load the second semi-rigid container, in the expanded position, into the receptacle 140; and trigger the sidewall retainer 150 to engage the upper sidewall of the second semi-rigid container. In response to receiving a second order specifying product types of product units, the central controller can implement methods and techniques described above to: assign a dispensing unit 104 to dispense a product unit of a product type specified in the second order; and trigger the mobile robotic system 110 to navigate the dispensing unit 104 to fulfil the second order. Therefore, the central controller can trigger the bag loader 170 to autonomously load a new semi-rigid container into the receptacle 140, accurately aligned to the receptacle 140, to maintain bag shape integrity and readiness for subsequent product dispensation.

### 14. Order Fulfillment: Mobile Robotic System+Tote

Blocks of the method S100 recite: receiving an order specifying a product type of a product unit in Block S110; and triggering the mobile robotic system 110 to retrieve a tote 130, loaded with a semi-rigid container, from the tote pickup zone in Block S126. Generally, the central controller can: receive an order specifying a list of product types; trigger the mobile platform 112 (i.e., the unloaded platform) devoid of a tote 130 to retrieve the tote 130 (i.e., the loaded tote 130) loaded with the semi-rigid container; trigger the mobile platform 112 (i.e., the loaded platform) to maneuver the tote 130 through the order fulfillment facility to fulfill the order; and trigger the mobile platform 112 to deliver the tote 130 (i.e., the filled tote 130) to the unloading zone (e.g., for retrieval by a customer). Then, in response to receiving a new order, the central controller can trigger the mobile platform 112 (i.e., the unloaded platform) to maneuver to the tote pickup zone to retrieve a new tote 130 loaded with a new semi-rigid container.

In one implementation, the mobile robotic system 110 is configured to: receive a tote 130 at the tote seat 116 on the mobile platform 112; navigate to a loading zone proximal a dispensing unit 104 loaded with a tray 102 storing product units of a product type specified in an order; and maneuver the tote 130 to align a semi-rigid container, loaded in a receptacle 140 of the tote 130, to the dispensing unit 104 to receive a product unit at a target unoccupied subvolume within the semi-rigid container. In this implementation, the central controller can: trigger the mobile platform 112 to autonomously navigate to the tote pickup zone to receive the tote 130 at the tote seat 116; trigger the mobile platform 112 to autonomously navigate to the loading zone adjacent the dispensing unit 104; implement methods and techniques described above to select the target unoccupied subvolume for receiving the product unit within the semi-rigid container; trigger the mobile robotic system 110 to maneuver within the loading zone to locate the semi-rigid container to receive the product unit at the target unoccupied subvolume; and trigger the dispensing unit 104 to dispense the product unit into the semi-rigid container. In particular, the mobile robotic system 110 can locate the tote 130 within the loading zone with the front side of the tote 130 (i.e., proximal the semi-rigid container opening) facing the dispensing unit 104.

### 14.1 Local Maneuvers at Dispensing Unit+Autonomous Product Retrieval

Block S122 of the method recites triggering the mobile platform 112 to align the tote 130 to the dispensing unit 104 to receive a product unit of the product type in the target unoccupied subvolume. In one implementation, in Block S122, the mobile robotic system 110 is configured to autonomously align the receptacle 140 to the dispensing unit 104 to receive a product unit at a target unoccupied subvolume within the semi-rigid container. In this implementation, the central controller can: trigger the mobile platform 112 laterally maneuver the tote 130 to align the semi-rigid container to the dispensing unit 104 (e.g., the set of dispensing arms 106) to receive a product unit at a target lateral position within the semi-rigid container; and trigger the elevator 114 to vertically maneuver the tote 130 to locate the semi-rigid container to receive the product unit at a target vertical position within the semi-rigid container. The central controller can then trigger the dispensing unit 104 to dispense the product unit into the semi-rigid container.

### 14.2 Multi-Product Dispense+Multiple Receptacles in Tote

In one variation, the mobile robotic system 110 can implement methods and techniques described above to maneuver the tote 130 at the dispensing unit 104 during dispensation of multiple product units (i.e., by a single dispensing unit 104) into the semi-rigid container. In another variation, the mobile robotic system 110 can implement methods and techniques described above to navigate through the order fulfillment facility, loaded with the tote 130, to retrieve product units from multiple dispensing units 104.

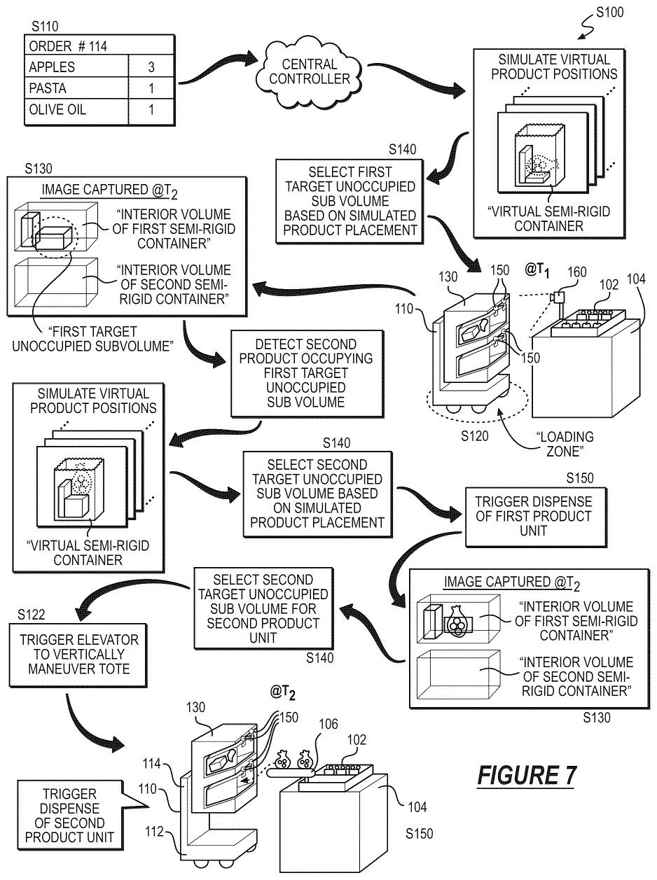

In one example, as shown in FIG. 7, a tote 130 includes: a first receptacle 140 configured to transiently house a first semi-rigid container; and a second receptacle 140, arranged below the first receptacle 140, configured to transiently house a second semi-rigid container. In this example, the mobile robotic system 110 includes an elevator 114 configured to locate the tote 130 over a range of vertical positions to receive product units in the first and second semi-rigid containers during fulfillment of an order (or multiple orders). In this example, the central controller can: receive an order specifying a first product type and a second product type; identify a tray 102 transiently storing product units of the first product type and product units of the second product type; assign a dispensing unit 104 for dispensation of product units of the first product type and the second product type from the tray 102; and trigger the mobile robotic system 110 to navigate to the loading zone proximal the dispensing unit 104.

The central controller can then trigger the optical sensor 160—arranged at the dispensing unit 104—to capture a first image at a first time when the mobile robotic system 110 occupies the loading zone. In particular, the optical sensor 160 can define a field of view intersecting the first interior volume of the first semi-rigid container and the second interior volume of the second semi-rigid container when the mobile robotic system 110 occupies the loading zone.

The central controller can then: detect an unoccupied volume within the first semi-rigid container and an unoccupied volume within the second semi-rigid container at the first time based on the first image; and, in response to identifying a first unoccupied subvolume, encompassing a first geometry of the first product type, within the first semi-rigid container, select a first unoccupied subvolume, for the first product unit. The central controller can then: trigger the optical sensor 160 to capture a second image at a second time following dispensation of the first product unit into the first semi-rigid container; and detect an unoccupied volume within the first semi-rigid container and an unoccupied volume within the second semi-rigid container at the second time based on the second image. In response to absence of an unoccupied subvolume, within the first semi-rigid container, compatible with a second geometry of the second product type, the central controller can: identify a second unoccupied subvolume, encompassing the first geometry of the second product type, within the second semi-rigid container; and select the second target unoccupied subvolume, intersecting the second unoccupied subvolume, for the second product unit.

The central controller can then: trigger the elevator 114 to vertically maneuver the tote 130 to locate the first semi-rigid container to receive the first product unit at the first target unoccupied subvolume within the first semi-rigid container; trigger the elevator 114 to vertically maneuver the tote 130 to locate the second semi-rigid container to receive the second product unit at a second target unoccupied subvolume within the second semi-rigid container; and trigger the dispensing unit 104 to dispense the second product unit into the second semi-rigid container. Thus, in this example, the central controller can prioritize placement of the second product unit within the first semi-rigid container (e.g., to maximize packing density) and select the second target unoccupied subvolume for the second product unit within the second semi-rigid container in response to absence of a viable position within the first semi-rigid container. Accordingly, the central controller can coordinate actuation of the elevator 114 to position the tote 130 at a vertical height corresponding to the target semi-rigid container selected for each product unit.

### 14.3 Order Completion+Tote Delivery

Generally, upon fulfillment of an order, the mobile robotic system 110 can navigate to an unloading zone. In one variation, the mobile robotic system 110 can navigate to the unloading zone for delivery or removal (e.g., manual removal, autonomous removal) of the tote 130 from the mobile platform 112. In another variation, the mobile robotic system 110 can navigate to the unloading zone (e.g., a tote 130 delivery zone) for removal (e.g., manual removal, autonomous removal) of the semi-rigid container from the receptacle 140.

In one example, the mobile robotic system 110 can navigate the tote 130 to a pickup station, in a set of pickup stations, located within the facility (e.g., located in an external-facing wall of the facility) and including an autonomously-actuated window. In this example, a customer may retrieve the semi-rigid container from the receptacle 140 via the autonomously-actuated window. In another example, the mobile robotic system 110 can: navigate the tote 130 to a pickup station located within the facility; and, via the elevator 114, vertically maneuver the receptacle 140 to a target height (e.g., an ergonomic height for manual retrieval) for manual removal of the semi-rigid container from the receptacle 140. Alternatively, in the preceding examples, a customer may manually retrieve product units from the receptacle 140, such as to transfer these product units to a reusable tote provided by the customer.

In one example, the mobile robotic system 100 can deliver the tote 130 to a staging rack, in a set of staging racks located in the facility, to await retrieval and delivery to an unloading zone by the same or a different mobile robotic system 110. In particular, the tote staging racks can be located in ambient space or in refrigerated enclosures within the facility, such as to maintain cold storage temperatures for chilled or frozen product units.

In one example, the mobile robotic system 110 can: implement methods and techniques described below to autonomously fulfill a particular order during a first time window (e.g., between 4:00 AM and 4:15 AM) prior to a target fulfillment time (e.g., 8:00 AM) for the order; and deliver the first tote 130 to a first staging rack prior to the target fulfillment time. In particular, during the first time window, the mobile robotic system 110 can: navigate to the tote pickup zone to retrieve a first tote 130, loaded with a first semi-rigid container, from the tote pickup zone; navigate to a loading zone to receive a first product unit, dispensed by the dispensing unit 104, within the first semi-rigid container; and navigate to a first tote staging rack, in the set of tote staging racks, configured to transiently store the first tote.

Then, during a second time window succeeding the first time window, the mobile robotic system 110 can: navigate to the set of tote staging racks to retrieve the first tote 130, loaded with the first semi-rigid container containing the first product unit, from the first staging rack transiently storing the first tote 130; and navigate to a tote delivery zone to deliver the first tote 130. Thus, in this example, the order fulfillment system can selectively assign the mobile robotic system 100 to pre-pack the order in advance of high-demand time periods (e.g., between 8:00 AM and 10:00 AM) characterized by relatively-high order demand (or order pickup throughput), without requiring order staging outside of the order fulfillment system.

In one variation, as shown in FIG. 9, upon removal or retrieval of the tote 130 from the mobile platform 112, the mobile robotic system 110 can navigate to a tote pickup zone to retrieve a new tote 130 loaded with empty semi-rigid containers. In one example, the central controller: receives a first order specifying a first product type; triggers the mobile robotic system 110 to retrieve a first tote 130, loaded with a first semi-rigid container, from the tote pickup zone; triggers the mobile robotic system 110, loaded with the first tote 130, to navigate to a dispensing unit 104 to retrieve the first product unit; and, in response to completion of the first order, triggers the mobile robotic system 110 to deliver the first tote 130 to the delivery zone. The central controller then: receives a second order specifying a second product type; triggers the mobile robotic system 110 to retrieve a second tote 130, loaded with a second semi-rigid container, from the tote 130 retrieval zone; and implement methods and techniques described above to trigger the mobile robotic system 110 to autonomously fulfill the second order. Thus, in this example, by delivering the entire tote 130 to the unloading zone (i.e., rather than waiting for manual removal of individual semi-rigid containers), the mobile robotic system 110 can minimize idle time, maintain continuous fulfillment throughput, and immediately retrieve a subsequent tote 130 loaded with empty semi-rigid containers for the next order.

### 15. Variation: Container Type Based on Fulfillment Order

In one variation, the central controller can: receive a fulfillment order specifying a quantity of product units of a product type; identify a container type configured to receive product units of the product type; and trigger the bag loader 170 to load the receptacle 140 with a container of the container type.

In one example, the controller: receives a fulfillment order specifying a quantity of two wine bottles; identifies a multi-compartment box type configured to receive individual bottles within a set of discrete compartments; and triggers the bag loader 170 to load the receptacle 140 with a multi-compartment box. In another example, the controller: receives a fulfillment order specifying a quantity of one pint of ice cream; identifies an insulated grocery bag type configured to maintain product units within a target temperature range; and triggers the bag loader 170 to load the receptacle 140 with an insulated grocery bag. Thus, in this variation, the central controller can trigger the bag loader 170 to load the receptacle 140 with a container of a particular container type based on products specified in the fulfillment order.

In one variation, the tote 130 (or the mobile robotic system 110) defines a set of (i.e., two or more) receptacles 140, wherein each receptacle 140 is configured to transiently house a variety of container types (e.g., semi-rigid containers, or reusable tote 130 bags). Furthermore, each receptacle 140 can transiently house the same container type, or a different container type from the adjacent receptacle 140(s).

For example, in one configuration, the tote 130 includes: a first receptacle 140 transiently housing a semi-rigid container; and a second receptacle 140 arranged below the first receptacle 140 and transiently housing a multi-compartment box. In this example, a particular order may specify a quantity of two pasta boxes and a quantity of six olive oil bottles. The mobile robotic system 110 can thus maneuver through the order fulfillment facility: to locate the tote 130 proximal a first dispensing unit 104 to receive the pasta boxes within the semi-rigid container; and to locate the tote 130 proximal a second dispensing unit 104 to receive each olive oil bottle in a particular compartment within the multi-compartment box. Therefore, the tote 130 can be configured to receive one or more containers based on products specified in orders to ensure secure and efficient packing of a population of product types. For example, the central controller can assign container types according to temperature control and safety-classification requirements specified in the fulfillment order. In one example, the system can allocate containers to separate zones, such as frozen, refrigerated, ambient, or non-food chemical categories, to preserve quality and prevent cross-contamination between these different product units.

### 16. Variation: Tote Rotational Actuator

In one variation, the mobile platform 112 is configured to rotate the tote 130 through a rotational plane intersecting a longitudinal tote axis (e.g., perpendicular to a base of the tote 130) to adjust the receptacle angle. In this variation, the mobile platform 112 further includes a rotational actuator coupled to the mobile platform 112 engagement features and configured to rotate the tote 130 through the rotational plane to dynamically adjust the receptacle angle, such as based on the position of the dispensing unit 104 or the product type dispensed.

### 17. Variation: Tote Rotator

In one variation, the order fulfillment system 100 includes: a tote 130 rotator configured to transition a tote 130 between an upright position and a horizontal position to align the tote 130 with dispensing units 104 or unloading systems as the tote 130 transitions through various stages of the order fulfillment process. In particular, in the upright position, the tote 130 locates the upward-facing aperture 146 of the receptacle 140 in a relatively forward-facing direction to receive product units dispensed by the dispensing units 104. In the horizontal position, the tote 130 locates the upward-facing aperture 146 of the receptacle 140 in a relatively upward-facing direction for retrieval of the semi-rigid container.

In one example, the order fulfillment system 100 includes: a bag loader 170 configured to load a semi-rigid container into the receptacle 140 with the tote 130 in the horizontal position; a first tote 130 rotator located within the tote 130 loading zone and configured to receive the tote 130 (i.e., the loaded tote 130) and rotate the tote 130 (e.g., 90 degrees) through the rotational plane from the horizontal position to the upright position; and a mobile platform 112 configured to receive the tote 130 in the upright position and maneuver the tote 130, in the upright position, through the order fulfillment facility to receive products.

In this example, the mobile platform 112 can be configured to deliver the tote 130, in the upright position, proximal an unloading zone. Additionally, in this example, the order fulfillment system 100 includes a second tote 130 rotator located within the delivery zone and configured to receive the tote 130 (i.e., the filled tote 130) and rotate the tote 130 (e.g., 90 degrees) through the rotational plane from the upright position to the horizontal position prior to delivery to the customer retrieval zone.

### 18. Variation: Trap Door

In one variation, the tote 130 can further include a trap door arranged proximal the receptacle base 142 and configured to actuate to permit passage of the semi-rigid container from the receptacle 140. In particular, in this variation, the trap door can be configured to: in a closed position, support the base of the semi-rigid container to retain the semi-rigid container within the receptacle 140; and, in an opened position, permit passage of the semi-rigid container from the semi-rigid container (e.g., permit the semi-rigid container to drop or slide out of the receptacle 140).

In this variation, the mobile robotic system 110 can implement methods and techniques described above: to fulfill an order by retrieving products from the dispensing units 104 (i.e., with the trap door in the closed position); and to maneuver the tote 130 to the unloading zone. Then, at the unloading zone, the local controller (or the central controller) can trigger the trap door to actuate from the closed position to the opened position to permit passage of (e.g., eject) the semi-rigid container from the receptacle 140.

In one example, at the unloading zone, the local controller can trigger the trap door to actuate to the open position to permit the semi-rigid container to slide out of the receptacle 140 and onto the delivery conveyor (i.e., for delivery to the customer retrieval zone).

In another example, at the unloading zone, the local controller can trigger the trap door to actuate to the open position to permit the semi-rigid container to slide out of the receptacle 140 and into a pickup locker (e.g., of a self-service pickup locker system), wherein a customer and/or a delivery worker may retrieve the semi-rigid container.

In another variation, the mobile robotic system 110 can include: the receptacle 140 (e.g., an integrated receptacle 140) configured to transiently house a semi-rigid container for receiving products; and a trap door arranged proximal the receptacle base 142 and configured to permit passage of the semi-rigid container from the receptacle 140.

Thus, in this variation, the tote 130 and/or mobile robotic system 110 can include the trap door to streamline the semi-rigid container unloading process by autonomously removing (e.g., ejecting or permitting passage of) the semi-rigid container from the receptacle 140 without requiring separate detachment of the tote 130 and/or manual intervention to remove the semi-rigid container.

### 19. Variation: Retractable Ram+Autonomous Container Unloader

In one variation, the tote 130 (or the mobile robotic system 110) can further include a retractable ram arranged within the receptacle 140 and configured to extend outwardly to push the semi-rigid container out of the receptacle 140. In one example, the tote 130 includes a receptacle 140 defined by the receptacle base 142 and a set of four receptacle walls 144 and including an upward-facing aperture 146 arranged opposite the base. In this example, the retractable ram is arranged proximal the receptacle base 142 and configured to extend outwardly to push the semi-rigid container along the central receptacle axis and out of the upward-facing aperture 146.

In another example, the tote 130 includes a receptacle 140 defined by the receptacle base 142 and a set of three receptacle walls 144. In this example, the tote 130 is configured to permit access to the receptacle 140 via a side-facing aperture arranged proximal a side (i.e., devoid of a receptacle wall 144) of the receptacle 140. In this example, the retractable ram is arranged proximal a first receptacle wall 144 opposite the side-facing aperture and configured to extend outwardly to push the semi-rigid container laterally out of the side-facing aperture.

In particular, in this variation, the mobile platform 112 can be configured to implement methods and techniques described above: to fulfill an order by retrieving products from the dispensing units 104 (i.e., with the ram in a retracted position); and to maneuver the tote 130 to the unloading zone. Then, at the unloading zone, the local controller (or the central controller) can trigger the ram to actuate from a retracted position to an extended position to push the semi-rigid container out of the receptacle 140 to a designated unloading location, such as a delivery conveyor or pickup locker.

In one variation, the local controller can trigger the ram to actuate from the retracted position to the extended position to locate the semi-rigid container in a transfer position for retrieval by an autonomous container unloader (or a “container unloader”) configured to unload the semi-rigid container from the receptacle 140. The local controller can then trigger the semi-rigid container unloader to engage the semi-rigid container (e.g., via a set of forks, a set of grippers, or a hook) and transfer the semi-rigid container from the receptacle 140 to a designated unloading location (e.g., the delivery conveyor, or a self-service pickup locker). Thus, the tote 130 can be configured with the retractable ram and/or configured to cooperate with a semi-rigid container unloader to streamline the semi-rigid container unloading process by autonomously removing or discharging the semi-rigid container from the receptacle 140 without requiring separate detachment of the tote 130 and/or manual intervention to remove the semi-rigid container.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A system comprising:
a dispensing unit, in a set of dispensing units, configured to dispense product units;
a mobile robotic system:
comprising:
a mobile platform;
a receptacle:
arranged over the mobile platform; and
configured to:
transiently receive a semi-rigid container;
support a first sidewall of the semi-rigid container at a first angle, angularly offset from a horizontal plane by a first pitch offset; and
support a base of the semi-rigid container; and
a sidewall retainer configured to retain a second sidewall, opposite the first sidewall, of the semi-rigid container to maintain access to an interior volume of the semi-rigid container; and
configured to:
navigate to a first loading zone proximal the dispensing unit;
maneuver within the first loading zone to align the semi-rigid container to the dispensing unit; and
receive a first product unit within the semi-rigid container; and
wherein the dispensing unit is configured to:
insert a distal end of the dispensing unit into the interior volume of the semi-rigid container; and
dispense the first product unit into the semi-rigid container, the first product unit falling from the dispensing unit toward the first sidewall of the semi-rigid container and descending into the semi-rigid container along the first sidewall to settle between the first sidewall and the base of the semi-rigid container.

2. The system of claim 1:
further comprising a first tray, in a population of trays, comprising:
a first opening; and
a first set of supports:
arranged over the first opening;
defining a first set of lanes within the first tray; and
configured to support product units within the first set of lanes; and
wherein the dispensing unit comprises a set of dispensing arms configured to:
pass through the first opening of the first tray toward the first set of supports;
elevate through a first lane, in the first set of lanes, to lift a first row of product units, stored in the first lane between a first pair of supports, above the first lane;
drive horizontally toward the first loading zone to extend into the interior volume of the semi-rigid container; and
drive the first row of product units forward toward the first loading zone to dispense the first product unit into the semi-rigid container.

3. The system of claim 1, wherein the receptacle is configured to transiently receive the semi-rigid container:
operable in:
a collapsed position with the semi-rigid container flattened; and
an expanded position, wherein the semi-rigid container defines the interior volume; and
comprising:
the base;
the first sidewall;
the second sidewall opposite the first sidewall;
a pair of sidewalls, each sidewall in the pair of sidewalls:
interposed between the first sidewall and the second sidewall; and
configured to deform along fold lines to transition the semi-rigid container from a collapsed position to the expanded position; and
a semi-rigid material configured to partially maintain a geometry of the interior volume when the semi-rigid container is in the expanded position.

4. The system of claim 3:
further comprising a controller configured to select a first target unoccupied subvolume for the first product unit within the semi-rigid container based on:
a first geometry of a first product type of the first product unit; and
a geometry of the interior volume when the semi-rigid container is in the expanded position;
wherein the receptacle is configured to:
support the first sidewall and the base of the semi-rigid container to maintain the geometry of the interior volume during dispensation of the first product unit into the semi-rigid container; and
wherein the sidewall retainer is configured to:
retain the second sidewall of the semi-rigid container to constrain deformation of the pair of sidewalls and maintain the semi-rigid container in the expanded position to permit passage of the first product unit into the interior volume of the semi-rigid container.

5. The system of claim 1:
further comprising an optical sensor:
located proximal the dispensing unit;
angularly offset from the horizontal plane; and
defining a field of view intersecting the interior volume of the semi-rigid container when the mobile robotic system occupies the first loading zone; and
further comprising a controller configured to:
access an image captured by the optical sensor and depicting the interior volume of the semi-rigid container;
detect an unoccupied volume within the semi-rigid container based on the image;
access a first geometry of a first product type of the first product unit; and
select a first target unoccupied subvolume, in the unoccupied volume, for the first product unit within the semi-rigid container, the first target unoccupied subvolume encompassing the first geometry of the first product type.

6. The system of claim 1:
further comprising an optical sensor:
located proximal the dispensing unit; and
defining a field of view intersecting the interior volume of the semi-rigid container when the mobile robotic system occupies the first loading zone;
further comprising a controller configured to:
access an image captured by the optical sensor and depicting the interior volume of the semi-rigid container;
detect an unoccupied volume within the semi-rigid container based on the image;
detect a second product unit occupying a second subvolume within the interior volume based on features depicted in the image; and
select a first target unoccupied subvolume, in the unoccupied volume, for the first product unit within the semi-rigid container, the first target unoccupied subvolume located above the second subvolume; and
wherein the mobile robotic system further comprises an elevator configured to vertically maneuver the receptacle to locate the semi-rigid container to receive the first product unit at the first target unoccupied subvolume above the second product unit.

7. The system of claim 1:
further comprising a tray, in a population of trays, defining a first lane:
arranged proximal a lateral position within the tray; and
configured to store a first row of product units of a first product type of the first product unit;
wherein the dispensing unit comprises a set of dispensing arms configured to:
elevate through the first lane of the tray;
lift the first row of product units, above the tray, to a dispense height; and
drive the first row of product units forward to dispense the first product unit toward the first loading zone;
further comprising a controller configured to:
access an image captured by an optical sensor, arranged at the dispensing unit, and depicting the interior volume of the semi-rigid container;
detect an unoccupied volume within the semi-rigid container based on the image;
access a first geometry of the first product type of the first product unit; and
select a first target lateral position, a first target vertical position, and a first target depth of the first product unit within the semi-rigid container, the first target lateral position, the first target vertical position, and the first target depth intersecting a first target unoccupied subvolume, in the unoccupied volume, encompassing the first geometry of the first product type; and
wherein the mobile robotic system:
is configured to laterally maneuver the receptacle to align the semi-rigid container to the lateral position of the first lane of the tray to receive the first product unit at the first target lateral position; and
further comprises an elevator configured to vertically maneuver the receptacle, based on the dispense height, to locate the semi-rigid container to receive the first product unit at the first target vertical position.

8. The system of claim 7:
wherein the controller is further configured to:
select a target vertical offset between the set of dispensing arms and the first sidewall of the semi-rigid container that:
avoids damage to the first product unit during dispense of the first product unit from the set of dispensing arms toward the first sidewall of the semi-rigid container; and
yields controlled descent of the first product unit along the first sidewall of the semi-rigid container, supported at the first angle, toward the first target lateral position, the first target vertical position, and the first target depth; and
select a target longitudinal position of the set of dispensing arms based on the target vertical offset; and
wherein the set of dispensing arms are configured to:
drive horizontally toward the target longitudinal position to extend into the interior volume of the semi-rigid container and over the first sidewall of the semi-rigid container at the target vertical offset; and
drive the first row of product units forward toward the first loading zone to dispense the first product unit at the target vertical offset.

9. The system of claim 1:
further comprising a controller configured to:
generate a virtual semi-rigid container representing a virtual unoccupied volume within the virtual semi-rigid container with the virtual semi-rigid container in a virtual angled position;
simulate a population of virtual product configurations within the virtual semi-rigid container, each virtual product configuration representing a virtual product unit of a first product type of the first product unit occupying a virtual unoccupied subvolume in the virtual unoccupied volume;
for each virtual product configuration:
calculate a virtual center of mass of a virtual semi-rigid container, in a virtual upright position, loaded with the virtual product unit occupying a virtual unoccupied subvolume based on:
a first geometry of the first product type;
a first mass of the first product type; and
an estimated virtual position of the virtual product unit with the virtual semi-rigid container in the virtual upright position; and
converge on a first virtual product configuration, in the population of virtual
product configurations, corresponding to a first virtual semi-rigid container exhibiting a lowest center of mass and loaded with the virtual product unit occupying a first virtual unoccupied subvolume; and
wherein the mobile robotic system is configured to maneuver the receptacle to locate the semi-rigid container to receive the first product unit at a first target unoccupied subvolume, corresponding to the first virtual unoccupied subvolume, within the semi-rigid container.

10. The system of claim 1:
further comprising a controller configured to:
generate a virtual semi-rigid container representing a virtual unoccupied volume within the virtual semi-rigid container with the virtual semi-rigid container in a virtual angled position;
simulate a population of virtual product configurations within the virtual semi-rigid container, each virtual product configuration representing a virtual product unit of a first product type of the first product unit occupying a virtual unoccupied subvolume in the virtual unoccupied volume;
for each virtual product configuration:
calculate a virtual packing density of a virtual semi-rigid container, in a virtual upright position, loaded with the virtual product unit occupying a virtual unoccupied subvolume based on:
a total occupied subvolume of the virtual semi-rigid container occupied by virtual product units; and
a remaining unoccupied subvolume of the virtual semi-rigid container; and
converge on a first virtual product configuration, in the population of virtual product configurations, corresponding to a first virtual semi-rigid container exhibiting a maximum virtual packing density and loaded with the virtual product unit occupying a first virtual unoccupied subvolume; and
wherein the mobile robotic system is configured to maneuver the receptacle to locate the semi-rigid container to receive the first product unit at a first target unoccupied subvolume, corresponding to the first virtual unoccupied subvolume, within the semi-rigid
container.

11. The system of claim 1:
further comprising an optical sensor:
arranged proximal the dispensing unit; and
defining a first field of view intersecting the first loading zone;
further comprising a controller configured to:
during a first time period:
simulate a first population of virtual product configurations within a first virtual semi-rigid container, each virtual product configuration representing a first virtual product unit of a first product type of the first product unit occupying a virtual unoccupied subvolume in a first virtual unoccupied volume of the first virtual semi-rigid container; and
converge on a first virtual product configuration, in the first population of virtual product configurations, representing the first virtual product unit occupying a first virtual unoccupied subvolume in the first virtual unoccupied volume; and
during a second time period succeeding the first time period:
trigger the optical sensor to capture an image depicting the interior volume of the semi-rigid container in response to the mobile robotic system occupying the first loading zone;
interpret a second product unit occupying a first subvolume, corresponding to the first virtual unoccupied subvolume, within the interior volume based on features depicted in the image; and
in response to the second product unit occupying the first subvolume:
simulate a second population of virtual product configurations within a second virtual semi-rigid container, each virtual product configuration representing the first virtual product unit occupying a virtual unoccupied subvolume in a second virtual unoccupied volume of the second virtual semi-rigid container; and
converge on a second virtual product configuration, in the second population of virtual product configurations, representing the first virtual product unit occupying a second virtual unoccupied subvolume in the second virtual unoccupied volume; and
wherein the mobile robotic system is configured to:
during the second time period:
maneuver the receptacle to locate the semi-rigid container to receive the first product unit at a target unoccupied subvolume, corresponding to the second virtual unoccupied subvolume, within the semi-rigid container.

12. The system of claim 1:
wherein the receptacle comprises:
a receptacle base configured to support the base of the semi-rigid container;
a first receptacle wall extending from the receptacle base and configured to support the first sidewall of the semi-rigid container at the first angle; and
a second receptacle wall, opposite the first receptacle wall, extending from the receptacle base;
wherein the sidewall retainer comprises a set of clips:
arranged proximal a second distal edge of the second receptacle wall; and
configured to:
retain the second sidewall of the semi-rigid container against the second receptacle wall of the receptacle in an engaged position; and
release the second sidewall of the semi-rigid container in a disengaged position; and
further comprising a controller configured to:
trigger the set of clips to the engaged position in response to the semi-rigid container occupying the receptacle;
trigger the mobile robotic system to navigate to an unloading zone for retrieval of the semi-rigid container, loaded with the first product unit, from the receptacle; and
in response to detecting a location of the mobile robotic system approaching the unloading zone, trigger the set of clips to the disengaged position.

13. The system of claim 1:
wherein the receptacle:
comprises a receptacle base configured to support the base of the semi-rigid
container; and
defines a center axis perpendicular to the receptacle base and arranged proximal the first angle;
further comprising a bag loader configured to:
transition the semi-rigid container from a collapsed position to an expanded position; and
load the semi-rigid container, in the expanded position, into the receptacle, along the center axis, to seat the base of the semi-rigid container against the receptacle base; and
wherein the sidewall retainer is configured to engage the second sidewall of the semi-rigid container in response to the semi-rigid container occupying the receptacle.

14. A system comprising:
a first tote, in a set of totes, comprising:
a first receptacle configured to:
transiently receive a first semi-rigid container;
support a first sidewall of the first semi-rigid container at an angle, angularly offset from a horizontal plane by a pitch offset; and
support a first base of the first semi-rigid container; and
a first sidewall retainer configured to maintain access to a first interior volume of the first semi-rigid container; and
a mobile robotic system:
defining a tote seat configured to transiently receive the first tote; and
configured to:
navigate to a loading zone proximal a dispensing unit, in a set of dispensing units, configured to dispense product units into the first semi-rigid container; and
maneuver the first tote to align the first semi-rigid container to the dispensing unit to receive a first product unit within the first semi-rigid container.

15. The system of claim 14:
wherein the first tote further comprises:
a second receptacle:
arranged below the first receptacle; and
configured to transiently receive a second semi-rigid container; and
a second sidewall retainer configured to maintain access to a second interior volume of the second semi-rigid container;
further comprising a controller configured to:
receive an order specifying a first product type and a second product type; and
assign the dispensing unit to dispense the first product unit of the first product type and a second product unit of the second product type; and
wherein the mobile robotic system further comprises an elevator configured to:
vertically maneuver the first tote to locate the first semi-rigid container to receive the first product unit within the first semi-rigid container; and
vertically maneuver the first tote to locate the second semi-rigid container to receive the second product unit within the second semi-rigid container.

16. The system of claim 15:
further comprising an optical sensor:
arranged proximal the dispensing unit; and
defining a field of view intersecting the first interior volume of the first semi-rigid container and the second interior volume of the second semi-rigid container when the mobile robotic system occupies the loading zone; and
wherein the controller is configured to:
trigger the optical sensor to capture a first image depicting the first interior volume of the first semi-rigid container at a first time in response to the mobile robotic system occupying the loading zone;
detect a first unoccupied volume within the first semi-rigid container and a second unoccupied volume within the second semi-rigid container at the first time based on the first image;
select a first target unoccupied subvolume, within the first unoccupied volume and encompassing a first geometry of the first product type, for the first product unit;
trigger the optical sensor to capture a second image at a second time following dispensation of the first product unit into the first semi-rigid container;
detect a third unoccupied volume within the first semi-rigid container and a fourth unoccupied volume within the second semi-rigid container at the second time based on the second image; and
in response to absence of a third target unoccupied subvolume, within the third unoccupied volume, encompassing a second geometry of the second product type:
select a fourth target unoccupied subvolume, within the fourth unoccupied volume and encompassing the second geometry of the second product type, for the second product unit.

17. The system of claim 14:
further comprising a second tote, in the set of totes, comprising a second receptacle configured to transiently receive a second semi-rigid container; and
wherein the mobile robotic system is configured to:
during a first time period:
navigate to a tote pickup zone to retrieve the first tote, loaded with the first semi-rigid container, from the tote pickup zone;
navigate to the loading zone, loaded with the first semi-rigid container, to receive the first product unit, dispensed by the dispensing unit, within the first semi-rigid container; and
navigate to a first tote staging rack, in a set of tote staging racks, configured to transiently store the first tote; and
during a second time period succeeding the first time period:
navigate to the set of tote staging racks to retrieve the second tote, loaded with the second semi-rigid container containing a second product unit, from a second staging rack, in the set of staging racks, transiently storing the second tote; and
navigate to a tote delivery zone to deliver the second tote.

18. The system of claim 14:
further comprising an optical sensor:
arranged proximal the dispensing unit; and
defining a field of view intersecting the loading zone;
further comprising a controller configured to:
access a first set of characteristics of a first product type of the first product unit;
access an image captured by the optical sensor and depicting the first interior volume of the first semi-rigid container;
detect an unoccupied volume within the first semi-rigid container based on the image; and
select a first target unoccupied subvolume, within the unoccupied volume, for locating the first product unit, the first target unoccupied subvolume compatible with the first set of characteristics of the first product type; and
wherein the mobile robotic system is configured to:
maneuver the first receptacle to align the first semi-rigid container to receive the first product unit at the first target unoccupied subvolume.

19. A system comprising:
a mobile robotic system:
comprising:
a mobile platform;
a receptacle:
arranged over the mobile platform;
configured to transiently receive a semi-rigid container; and
comprising:
a receptacle base configured to support a base of the semi-rigid container; and
receptacle wall:
extending from the receptacle base; and
configured to support a first sidewall of the semi-rigid container at an angle angularly offset from a horizontal plane by a pitch offset;
a sidewall retainer configured to retain a second sidewall, opposite the first sidewall, of the semi-rigid container to maintain access to an interior volume of the semi-rigid container; and
an elevator configured to locate the receptacle over a range of vertical positions; and
configured to:
navigate to a loading zone proximal a dispensing unit, in a set of dispensing units, configured to dispense product units into the semi-rigid container;
laterally maneuver within the loading zone to align the semi-rigid container to the dispensing unit; and
vertically maneuver the receptacle to locate the semi-rigid container to receive a product unit at a target unoccupied subvolume within the semi-rigid container.

20. The system of claim 19:
further comprising:
the dispensing unit configured to dispense product units from a tray loaded with product units and occupying the dispensing unit;
an optical sensor:
arranged proximal the dispensing unit; and
defining a field of view intersecting the loading zone; and
a controller configured to:
access a geometry of a product type of the product unit;
access an image captured by the optical sensor and depicting the interior volume of the semi-rigid container;
detect an unoccupied volume within the semi-rigid container based on the image; and
select the target unoccupied subvolume, within the unoccupied volume, for locating the product unit, the target unoccupied subvolume encompassing the geometry of the product type of the product unit.
